(19) United States
(12) Patent Application Publication
(10) Pub. No.: US 2020/0413217 A1
(43) Pub. Date: Dec. 31, 2020

(54) Software for Distance and Object Identification Deployed on Mobile Devices

(71) Applicant: Shimon Rothschild, (US)

(72) Inventor: Shimon Rothschild, Dallas, TX (US)

(73) Assignee: Shimon Rothschild, Dallas, TX (US)

(21) Appl. No.: 16/453,920

(22) Filed: Jun. 26, 2019

(51) Int. Cl. H04W 4/02; G06F 16/29; G06F 16/245; G01S 19/13

(52) U.S. Cl. CPC H04W 4/023; G06F 16/29; H04W 88/02; H04W 4/026; G01S 19/13; G06F 16/245

(57) ABSTRACT

Utilizing hardware in a mobile device, any object in sight or beyond, stationary or moving, can be identified. The steps include measuring the compass bearing that the mobile device is pointing and the device tilt. The intersection of the bearing line and a distance, as calculated by degrees of the tilt, indicates which object is selected. Using a data connection, the mobile device requests information about objects at the intersection. The data store responds with information about objects at the location and that information may be displayed or saved. Where a topographical map is displayed beneath the object, a GPS location is determined. The distance between the mobile device and the GPS location is based on the map scale, mobile device screen and GPS location of the mobile device. Tracking moving objects for identification is accomplished by maintaining the intersection on the object as it traverses the map.

### BACKGROUND OF THE INVENTION

Until now there has been no application of a stationary mobile device for selecting objects beyond the line of sight. For both games and real world applications it would be very useful to incorporate this functionality, using established paradigms, of the remote control and unpowered missile parabolas. Hardware limitations have discouraged implementation. Mobile devices generally do not have the hardware to measure distances. Mobile device software technology is evolving from and console game devices. Device hardware is much more capable. This problem could not be addressed on a desktop computation device and pointing a portable computation device at a house is not intuitive.

The challenge was identification of distance. Implementation of range finding with a mobile device can be accomplished using GPS, compass and device pitch. Utilizing a scale map and device sensors, GPS location, direction and pitch of the device direction can pinpoint a location for selection. The location selected is compared with data sets to discover the details of any object at that location. In some scenarios it can be used to view data about a building. In other scenarios it can be a game, where players are moving targets and the mobile device works as a paint-ball gun. Point and pitch for range to hit the target. If a miss, identify where the shot landed. The player adjusts direction and pitch to more accurately select the intended target.

The shape of a mobile device is similar to the shape of many remote controls. To control a room heater or air conditioner, point the remote at the unit and press the appropriate control button. Using a remote control to channel surf a television and control the volume is a very comfortable paradigm. This paradigm is now applied to object selection and identification. Object selection is beyond the line of sight, if the GPS location is on the map, it can be selected.

Given an opportunity, people want to know about their neighbors and in Internet age, immediate information is the norm. When not immediately available, then it can be perceived as an excessive effort. This invention enables an operator to learn about someone and something by point and click. Point the mobile device towards the dwelling, set the mobile device pitch for range and the aggregated information about the neighbor is now available. Information about places and people has become generally available to everyone through the internet. The existing process is multi-step on a mobile device, not universally known and retrieval from different services requires learning their specific steps to access the data. Here is an example. An individual wants details about a new neighbor.

For how much did they buy the house? Go to the web site of the county assessor, enter the address and the web site displays the results. Operator input must be correctly formatted, not intuitive, to get a result returned.

What are the names and phone numbers of the people living there? Go to a web site identify the home from a map displaying building roofs. Select the home and name and phone number information is displayed.

View social media information about the new neighbors: Go to each social media website (Facebook, Google+, Twitter and LinkedIn) enter each residents name, and view their profile. Does the neighbor have a criminal record? Go to a web site that identifies criminals and enter the name. The web site returns any convictions or if the person is a registered sex offender. The display of this information is by point, pitch and click. This is an existing implementation and demonstrates the invention.

What if an individual is passing a home and is curious to know who lives there? Following the steps currently in practice, it would be difficult. Point, pitch and click and an emergency unit uses it to identify residents, phone numbers other information associated with the object selected specific to their requirements. The existing implementation is to type an address into a computer. What if the emergency needs to contact a neighbor it is unnecessary to have the address, point, pitch and click for the information?

This invention provides these details based on the GPS location of the object. Point the mobile device at the object set pitch of the mobile device and using the device sensors the GPS location of the object is determined. From the GPS location, details about the objects and sub objects at the selected location can be obtained.

As a tool, GPS location based object identification can be accomplished by pointing the mobile device in the direction of the object. The challenge remains how to determine the distance of the object from the mobile device. This is accomplished by a combination of phone pitch and scale of the area of operation.

The same process is applied to a game of virtual tag. Game players benefit by having an original game. The mobile device functions as virtual tag, where multiple players on a map are moving and attempting to tag another player. This is an existing implementation and it demonstrates the invention. The game can be played solo where targets are system generated and the objective is to hit the target in the fewest shots.

With this invention the user can track and select a moving object for information. about the vehicle. This invention can identify a moving object based on broadcasted GPS locations and tracking the phone with modification of direction and tilt. Maintaining on the moving object, the intersection of the distance arc and the direction line, multiple common GPS locations with time intervals is sufficient to identify the object that is being tracked.

### Background Art

The use of a mobile device for object selection and identification exists. Different implementations support different purposes. Existing implementations are limited to short range, assumptions about distance and multiple readings from different locations. A line-of-sight requirement limits the distance range, assumptions restrict object selection and multiple readings require physical relocation of the mobile device. Direction can be determined from the built in compass. Current location is calculated from GPS positioning. For distance, a standard trigonometric equation based on the tilt of the device. An existing implementation using mobile device pitch to calculate distance is implemented with limitations that it is flat ground to target point and a maximum range of 15 meters (Patent Document 1). The present invention encompasses a hemisphere, and with additional maps it could encompass the entire hemisphere and into space. In another embodiment, it requires a two-shot workflow. This requires the operator to move between two different locations to measure a single location. By requiring two locations, the measurements may be difficult to repeat and verify.

A camera for object identification is limited to objects that can be viewed from the camera lens (Patent Document 2). This implementation is a competing technology, but is limited to line of sight and a finite range of options. The mobile device captures camera direction from the built in compass and current location from the GPS positioning. By rules of perspective the image is mapped to pre-defined three dimensional space. Where matched, items in the image can be identified. This implementation is limited to the street views.

Another implementation with a camera is identification of uniquely identified real property. The mobile device with compass and GPS positioning when pointed at an object, draws a line of sight until a predefined object is identified or line of sight ends without an object. If a predefined object is identified the details of the object are displayed. This implementation fulfills a niche market such as identification of real estate listing details. (Patent Document 3).

Mobile devices with laser rangefinders exists, but laser rangefinders are not generally available on mobile phones (Patent Document 4). These are for specific industries and limited by line of sight. The accuracy of a laser rangefinder significantly exceeds the accuracy required for object identification and not necessary for object identification.

There are various permutations on the core theme of map and line of site. To compensate for inaccuracy of line of sight and GPS location, another implementation utilizes a line of sight over a predefined grid. There is an example where it could select an object, but it requires at least two readings from different locations to determine a grid of interest. The readings must be sufficiently far apart for the point algorithm to correctly select the grid. This necessitates either an elapsed time between readings or multiple devices. If the object of interest is moving, is extremely unlikely to identify it, and impossible if the object crosses grids (Patent Document 5).

Another implementation uses a camera and image recognition to identify an object. This requires a clear line of sight. This also requires photo recognition algorithms. Image recognition for the identification of an object has limitations that have been addressed, such as the computational intensity. Because the appearance of stationary objects may change over time, the object identification may be difficult to repeat and verify. (Patent Document 6).

### CITATION LIST

Patent Document 1: U.S. Pat. No. 8,908,155 B2 Remote positioning
Patent Document 2: U.S. Pat. No. 7,720,436 B2 Displaying network objects in mobile devices based on geolocation
Patent Document 3: US 20130328931 A1 System and Method for Mobile Identification of Real Property by Geospatial Analysis
Patent Document 4: WO 1990012330 A2 Hand-held laser rangefinder
Patent Document 5: US 20140195300 A1 Site of interest extraction device, site of interest extraction method, and computer-readable recording medium
Patent Document 6: US 20120242842 A1 Terminal device, information processing device, object identifying method, program, and object identifying system

### BRIEF SUMMARY OF THE INVENTION

### Field of the Invention

The present invention relates to a location selection apparatus where a handheld mobile device is utilized as a direction indicator and a distance estimator to extract location details within, near and beyond the line of sight and to display those details on the mobile device screen and to store and retrieve the details in a computer readable recording medium.

The invention can identify any GPS location on Earth and provide details at the selected location. The steps to identify the GPS location is point the mobile device in the direction of the desired location and tilt the phone to identify distance. Direction is a straight line from the device and tilt indicates the radius distance from the device. Where the straight line and the radius arc intersect is the selected GPS location for identification. Change the direction the mobile device is pointing, changes the direction of the GPS location for identification. Change the tilt of the mobile device to indicate the distance from the mobile device.

Where the mobile device displays a top down map on a screen, the distance any location from the mobile device is calculated. The intersection over a specific location such as hill top or building on the displayed topographical map selects the location. This location has a GPS coordinate. Using map scale and screen resolution, the distance is calculated. The GPS location is sent to a database. The database retrieves information about objects at the GPS location. The information is returned from the database to the mobile device and displayed on the screen.

This is also applicable to objects in motion. When moving objects broadcast updated locations, the updates are stored in the database. When a mobile device is registered to receive updates of moving object, the database send the updated GPS location of the object. The screen of the mobile device updates the location of objects in motion. The moving object is identified by maintaining the intersection of the straight line and arc on the object. When enough GPS locations on the same object have been read, the database checks for objects known to travel through those locations at specified times. Information on the object is to the mobile device and displayed on the screen.

### Problem Solved by the Invention

The apparatus disclosed in this patent document is extremely useful for an operator to point at a target for identification and promptly view details of the target. Using the ubiquitous exemplar of pointing a finger at the desired target, the mobile device is pointed, as an extension of the hand, at the object by line of sight or utilization of a top down topographical view displayed on the mobile device. The top down view extends the field for object selection beyond line of sight. With a top down view, a map at any scale, the operator, by pointing the mobile device in the direction of the object, a vector passes through every object along that direction. To specify the specific object, the vector end point is determined by the pitch of the mobile device. The direction and the designated circumference determined by the pitch is overlaid on the top down view. The intersection of the direction vector and the circle representing the end points at the given pitch is the location of the selected object for identification. It is now possible to select objects beyond the line of sight and it is possible to accurately select objects at a single instance.

EXAMPLE 1: The present example is a game where the game generates a target on an actual map, based on centering on the operator GPS location. The operator points the mobile device in the direction of the computer generated target and holds the mobile phone at a pitch to indicate the distance. Based on the mobile device direction, the device pitch, and the type of virtual projectile selected, the player may miss, hit, damage or destroy objects at the selected location. The game repeats with new targets, maps and different sized projectile impact areas.

EXAMPLE 2: The present example is a tool to identify the registered residents in a home. The operator points the mobile device at a dwelling and the algorithms determine what home is selected based on location of the mobile device, the direction the mobile device is pointing and the mobile device pitch to select a building observable or not observable from the mobile device location. The algorithms identify the coordinates of the home and can display information about the residents, home value and other details associated with the house, such as names of listed residents.

EXAMPLE 3: The present example is a social interaction game where multiple operators appear on the same map. By aiming at another operator marked on the map, information about that operator can be displayed. In this scenario, it is like playing tag, point the mobile device at the target and the invention calculates if it is a tag, letting both individuals know the result. Selection is by simulation of a trajectory based on the mobile device pitch. This is analogous to launching an unpowered missile.

### Process Steps for Obtaining Object Identification

The following are the order of the steps and sample data to elucidate the steps used to identify an object.
1. Using GPS, identify the location of the device
2. Request from a map server a map at any specified scale. For this example, with the device at the center of the map.
3. The map is displayed on a pixelated screen. The map is centered on the device and the visible map ends at the edge of the screen.
4. Calculate the number of pixels per inch on the screen. This is accomplished by using built in device information.
5. Knowing the map scale because it was requested by the device, calculate the map distance relative to pixels on the screen. Example:
   a. Get a map and scale
   b. Requested map is one inch: one mile
   c. Pixelated screen is 326 pixels per inch (iPhone 4, 5 and 6)
   d. Therefore 326 pixels=one mile
6. Calculate 326 pixels from the device location. This is accomplished by using built in operating system methods to count pixels from any location to any other location. All pixel screens have this capability because this is the method for drawing.
7. The point under that location is one mile from the location of the device.
8. The location on the map at that point is requested from the map server. An invisible pin is placed at the center of the pixel and a request is made from the map server to provide the GPS coordinates of the invisible pin on the map.
9. The map server returns the coordinates.
10. Any change in the map, zooming or reorienting, use Pythagorean theorem to measure the pixel distance between the device location and the invisible pin. This capability is a property of the device.
11. The new number of pixels represents the modified scale of the map. This is necessary to determine the distance a selected object is from the device.
12. To indicate selected distance, use the phone pitch. For example, select the furthest point from the device location on screen, this is one of the four corners of a rectangular screen.
13. Determine the number of pixels from the device location to the furthest on screen location. Having calculated earlier the map distance and pixel distance between the invisible pin and the device location, the map distance of the furthest point is calculated.
14. Set a device pitch as degrees to equal the distance. For example, a 40-degree pitch identifies the furthest point. A 20-degree pitch equals ½ the distance (any scale can be implemented)
15. For convenience of the user, a circle is drawn with the center at the device location and the radius is the distance indicated by the pitch.
16. The mobile device has the capability to determine the direction that the device is pointed towards. Compass bearing is determined assuming the device is parallel to the ground (known limitation of compass readings). At device pitch, the compass reading is not true.
17. Knowing the device pitch and the reading of the compass, using standard trigonometry, calculate the true direction.
18. For convenience of the user, a straight line is drawn from the device location to screen edge, in the degree direction of the device.

Step 4: Calculate the Selected Location
19. At the intersection of the pitch circle and the compass line is the selected object.
20. Knowing the distance and direction, an invisible pin can be inserted at that pixel.
21. The GPS location of the invisible pin on the map is requested from and supplied by the map server.
22. It is at this GPS location that the user is requesting information of objects at the GPS location

Step 5: Object Details
23. Object information is stored based on GPS location. A list (data table) of object information is stored by GPS location.
24. The mobile device sends the selected GPS location to the list with a request of all objects at that GPS location and a radius around the location.
25. The list returns those objects at the GPS location or within a radius of the selected GPS location.
26. Any information about objects at the location or within the radius are displayed on the screen.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar parts throughout the several views of the drawings, and wherein:

FIG. 1 is a block diagram illustrating a system overview in accordance with an exemplary embodiment;

FIG. 2 is an explanatory diagram illustrating an image and information that can be displayed on a screen of a mobile device depicting how the details of an object might appear, in accordance with an exemplary embodiment;

FIG. 3 is a drawing and data table describing one example of direction azimuth and range calculation processing executed by an azimuth vector combined with a pitch calculation unit for object selection shown in FIG. 2;

FIG. 4 is a block diagram showing an exemplary logic diagram for how an object is selected for information in accordance with an embodiment shown in FIG. 2;

FIG. 5 is a second that is an explanatory diagram illustrating an image and information that can be displayed on a screen of a mobile device depicting how target selection might appear, in accordance with an exemplary embodiment;

FIG. 6 is a drawing and a data table. It shows the result of reading the mobile sensors and calculating objects in the range of the selected in accordance with an embodiment demonstrating coverage of an area around the selected GPS location show in FIG. 5;

FIG. 7 is a block diagram showing an exemplary logic of how information about objects are returned to the mobile device and the impact of target selection on the objects within radius as shown in FIG. 5;

FIG. 8 is a third example that is an explanatory diagram illustrating an image and information that can be displayed on a screen depicting how a map for measuring straight line distance might appear, in accordance with an exemplary embodiment;

FIG. 9 is a drawing and data table. It shows the result of reading the mobile sensors and calculating the straight line distance the selected in accordance with an embodiment demonstrating degree calculation processing executed by a range arc calculation unit for measuring straight line distance shown in FIG. 8;

FIG. 10 is a block diagram showing an exemplary logic diagram for how a destination distance can be measured, in accordance with an embodiment shown in FIG. 8;

FIG. 11 is an activity diagram showing an exemplary flow of data between the mobile device and the data store in accordance with the embodiment in FIG. 2;

FIG. 12 is a state transition diagram showing the states and transition gates in progressing through selecting an object in accordance with the embodiments shown in FIG. 5 and FIG. 8;

FIG. 13 is a use case diagram depicting how the mobile device uses vectors and pitch for selecting a GPS location;

FIG. 14 is an activity diagram depicting range accuracy retention during in zoom in and zoom out;

FIG. 15 is an activity diagram with swim lane breakdowns depicting the three objects, mobile device, moving object and data store and the activities, calls and branching decisions that that each object performs in communication with other objects;

FIG. 16 an explanatory diagram illustrating an image and information that can be displayed on a screen of a mobile device depicting how moving target selection might appear, in accordance with an exemplary embodiment;

FIG. 17 is a visual depiction of the meaning of the terms azimuth and pitch;

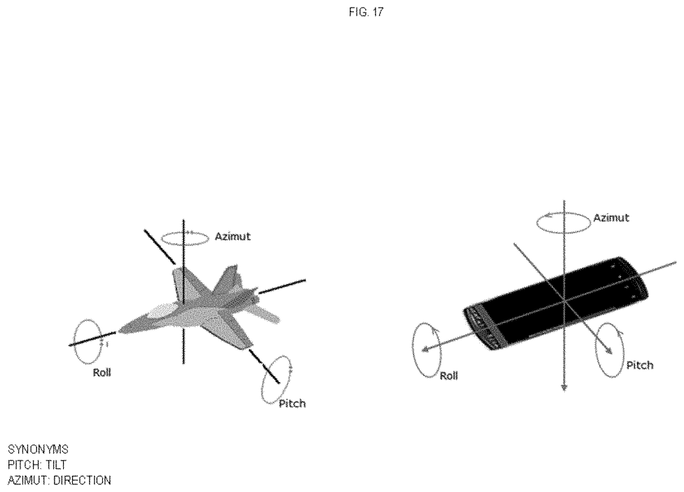

FIG. 18: A sketch demonstration of how a user uses the invention to aim and set range with the mobile device. The mobile device screen shots depict how the mobile device display the radius arc based on mobile device angle.

FIG. 19 is an activity diagram with swim lane breakdowns depicting activities generating the data necessary for the communication between the hand held device and the remote server, as a visualization in the claims, #1.

FIG. 20 is a sketch demonstration of example mobile devices that may implement the invention containing required sensors and implementing the same steps for the same result, as a visualization in the claims, #2.

FIG. 21 is an example of objects selected using a mobile device and information found and returned from the data store to the mobile device, as a visualization in the claims, #3.

FIG. 22 is a block diagram showing an exemplary step diagram of the steps in the invention to identify object location and the method to identify the location, as a visualization in the claims, #4.

FIG. 23 is a block diagram showing an exemplary step diagram for how a person uses the mobile device to identify object location and the method to identify the location from user actions, as a visualization in the claims, #10.

FIG. 24 is a block diagram showing an exemplary step diagram of how the execution of instructions fits in the chain of instructions, as a visualization in the claims,

### DETAILED DESCRIPTION OF ILLUSTRATIVE EMBODIMENTS

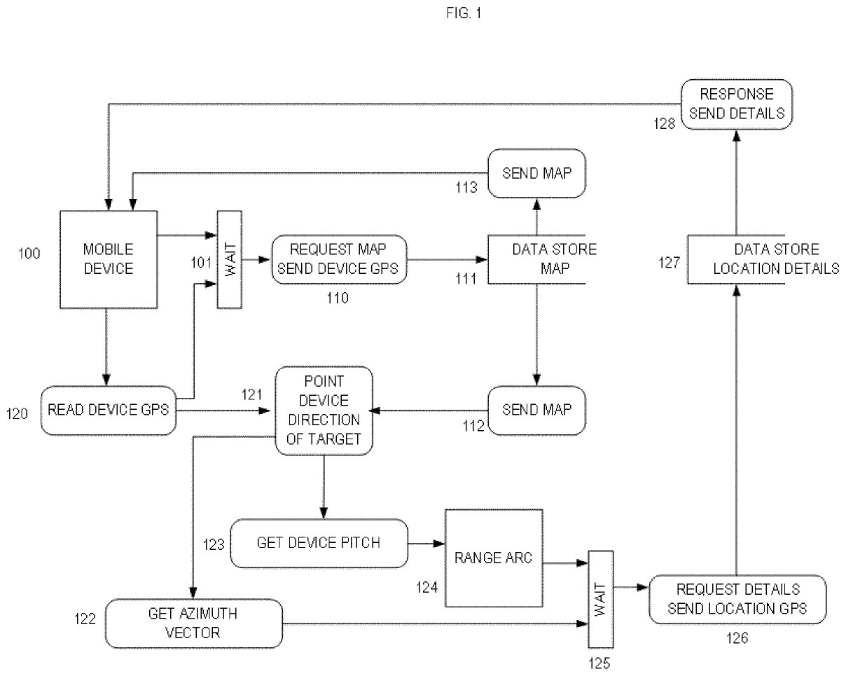

FIG. 1 is a block diagram illustrating a system overview showing an exemplary flow of the logical function implemented in the communication between the mobile device and the data store. It starts with the mobile device 100 and reads the GPS location of the device 120. With a GPS location 101, a request is made for a map 110 based on said GPS location. The data store queries for a map 111 centered on the GPS location. The data store responds with a map 113. The map is displayed on the mobile device 100. The map. The map 113 is used on the mobile device to for the operator to identify what target is selected. FIG. 112 and FIG. 113 are the same map. FIG. 112 is a virtual representation of the map and FIG. 113 is a physical manifestation. The operator points the mobile device 121 in the direction of the target, using the map and or visual observation. The direction of the mobile device 122 is used to determine the azimuth. An azimuth vector is created, from the GPS location of the mobile device at the azimuth. The operator points the mobile device upward at 123 to set the distance from the mobile device. Changing the pitch of the mobile device changes the distance 124 as depicted as an arc from the GPS location. At the intersection of the azimuth vector and the range arc 125 is the selected GPS location to be identified. A request is made for details 126 about objects at the GPS location to be identified. The data store queries for objects 127 at the GPS provided. The data store responds 128 with details of the objects at the GPS location to be identified.

The mobile device 100 requires no initialization. The mobile device attempts to read the GPS hardware sensor 120. Where there is no GPS sensor the mobile device provides notification. If there is a GPS sensor and no value due to insufficient GPS satellite values, the mobile device provides notification. When there is a GPS value and a need for a map 101, the device makes a request 110 based on a reading of the GPS sensor 120. The data store 111 uses the GPS location provided to generate a map centered on the GPS location. The data store provides a default scale for the mobile device to zoom in or zoom out. The data store responds and sends the map details 113 to the mobile device 100. The map 113 is the base for view and identification of the object that the operator is selecting. The operator points the mobile device as one would point a remote control towards the object to be controlled. This can be by visually pointing the device at the object or by using the map displayed 113 to select from the top down view. The operator is initially centered on the map and an azimuth vector corresponds with the direction 122 that the device is pointing. The operator tilts the forward edge 123 of the mobile device upward to signify distance. Because compass readings require that the device be parallel to the Earth, math algorithms are applied to compensate that the mobile device is pitched and the azimuth reading remains accurate. The distance is identified as a circle 124 around the mobile device GPS position on the map 113. The higher the pitch the greater the distance and this can be set that above forty-five degrees it is a mirror image of zero to forty-five degrees. The intersection of the azimuth vector and the range arc 125 is the point of selection. The point is converted to a GPS location and a request 126 for details about any objects included in that GPS location is made. The request can also be to identify all objects within a specified radius of the GPS location of the point of selection. The data store 127 identifies all objects that are included in the GPS location or within the radius of said GPS location. The data store responds and sends details of the objects 128 identified. If there are no objects identified a message as such is returned.

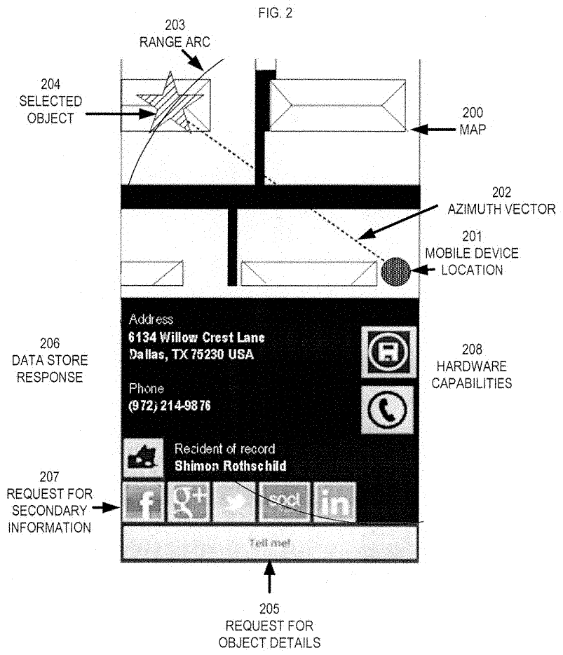

FIG. 2 is an embodiment of an implementation. It is an explanatory diagram illustrating an image and information that can be displayed on a screen of a mobile device. It starts with receiving a map FIG. 1 113. The map 200 is displayed on the screen of the mobile device. The mobile device location 201 is marked on the map for reference. The azimuth vector 202 points in the direction that the mobile device is pointing. Based on the mobile device pitch and the map scale 203 there is the range arc depicting the distance at any azimuth. The intersection 204 of the azimuth vector and the range arc is the location of the object being selected. 205 is an exemplary demonstration of how a request for object details is created. In an exemplary demonstration, the response 206 from the data store is displayed on the mobile device. Based on the results provided in the detail response from the data store, as an exemplary demonstration, a request for secondary information 207 is available. Based on the results provided in the detail response and the hardware capabilities of the mobile device, secondary operations 208 are available.

The map 200 is from the response sent FIG. 1 110. The map of objects FIG. 1 113. The GPS location of the mobile device is read and the map is centered on the mobile device. It is possible move the map and zoom in or zoom out on the scale of the map. The mobile device location is moved with the map. It is possible to move the map such that the mobile device location 201 is off the visible map 200. The mobile device location 201 is a visual reference point for an operator to logically understand how azimuth is calculated from the direction that the mobile device is pointing, but the calculation will remain accurate and any part of the vector on the map will be displayed. As an exemplary demonstration, the vector may be displayed and is correctly calculated even when the vector is not displayed.

As an alternate exemplary demonstration, the map 200 will rotate with the direction of the mobile device and the azimuth vector is not displayed and calculated by reading the map azimuth. In this embodiment there is the option to zoom in or zoom out, but movement of the map will cause the association of line of sight to map inconsistent. Limiting map 200 functions to zoom in and zoom out keeps the mobile device location 201 centered in the map. Relative to the scale of the map, when the mobile device location moves, the map will be redrawn to place the mobile device location again in the center of the map. To view objects that are outside the map view, zoom out the map. In this embodiment as the mobile device location moves, the map is redrawn at the same scale, retaining the same map size and positioning the mobile device location in the map center. This results that some objects that were visible on the map are not visible and some objects that were previously not visible on the map are now visible.

At all times the display representation of the mobile device location 201 is presented at the GPS location on the map. The location 201 is marked on the map 200 as the reference for calculating the azimuth of the object to be selected. The mobile device location 201 is the position from which the range arc emanates. As the GPS location of the mobile device changes, the mobile device location is updated on the map. When the mobile device location is off the map 200 the azimuth continues to be based on the updated mobile device position. At any time that the azimuth vector 202 crosses the map or the range arc crosses the map, it is displayed. Where the mobile device is in motion, to maintain the mobile device location visible on the map, it is necessary to zoom out the map. When the GPS position of the mobile device is again within the parameters of the map, it will be displayed at the correct GPS location on the map.

As an alternate exemplary demonstration, when the map 200 rotates with the azimuth of the mobile device the mobile device location remains at or near center of the map. In this embodiment, as the GPS position of the mobile device changes, the map maintains the scale and size. The objects viewed in the map may change. Objects further from the mobile device location may be removed from view because they are outside the map scale and size. Objects that are now within the map size and scale, based on the updated GPS location will appear on the map. To obtain view of objects outside the visible map, zoom out the map or move the mobile device in the direction of the object to be viewed.

The azimuth vector 202 indicates the line on which an object may be selected. This corresponds with the direction that the mobile device is directed. This is analogous to pointing a remote control and the object to be controlled. The azimuth vector emanates outward from the mobile device location 201 depicted on the map. As the mobile device is rotated towards different directions, the azimuth vector reflects the movement with the azimuth vector pointing the direction of the mobile device. Any object intersecting or within a specified delta of the azimuth vector may be selected as the object for identification. In this exemplary diagram the operator may point directly at the object to be selected. The azimuth vector indicates if the intended object is on the path for selection. At any map scale the operator has the option to select an object by pointing in the direction of the object as depicted in the top down view of the map 200. Where the scale is beyond the line of sight, the operator identifies the object to select from the map and points the mobile device in the direction of the object to select.

As an alternate exemplary demonstration, the azimuth vector 202 always points outward from the mobile device location 201 and the map 200 rotates according to the azimuth. The azimuth vector remains stationary as the map is rotated. An exemplary implementation on rectangular mobile device will have the azimuth vector always parallel to the sides of the mobile device.

The range arc 203 is a calculation based on the map 200 scale and the mobile device pitch. On initial display of the map the scale is a proportion to the mobile device pitch. An exemplary demonstration is that the initial position of the mobile device location 201 is centered in the map. The closest map edge is one mile. One mile is mapped to a predefined pitch, for example, forty-five or ninety degrees. The scale is mapped to the pitch such that the pitch ratio is the ratio away from the mobile device location. Zoom in or zoom out of the map does not change the original ratios. The ratios remain fixed until intentionally updated. The center of the range arc remain in the center of the mobile device location. As the mobile device moves, the center of the range arc moves and the entire range arc.

As an alternate exemplary demonstration, by zoom in or zoom out, the ratio of map scale to mobile device pitch is recalculated. On zoom, the range arc can remain fixed to the object at zoom or the range arc can retain the same visual size. The same visual size changes the proportion of scale to mobile device pitch.

The selected object 204 is the intersection of the azimuth vector 202 and the range arc 203. The GPS location is at the center of the intersection. Any changes of the mobile device location, mobile device direction or pitch requires a recalculating of the selected object GPS location. If the mobile device moves, then the arc moves as the center of the arc is the GPS location of the mobile device. If the mobile device is pointed in a different direction, then the azimuth vector is recalculated based on the new direction. If the mobile device pitch is altered, then the range arc reflects the updated ratio of device pitch as a proportion of the map scale. If the zoom in or zoom out modifies the ratios to accommodate the new map scale, then the selected object is that now under the intersection of the azimuth vector and the range arc.

A request for object details 205 is accomplished by explicitly requesting details of the object at the intersection of the azimuth vector 202 and the range arc 203. The GPS location of the selected object is the intersection of the vector and the arc. The GPS location of the selected object is included in the request.

As an alternate exemplary demonstration, a request for details is automatically generated when the intersection of azimuth vector and the range arc hover over an object.

The data store response 206 is the description of the object or objects that include the specified GPS location within the object area. Information on the selected object is made available. An embodiment of an implementation is the display of the information on the mobile device.

As an exemplary demonstration a request for different information from alternate sources 207 is based on the information provided in the response from the initial request 205 for object details. If a name is provided in the response from the request for object details 205, the name can be included in a request for details on the name.

As an exemplary demonstration, based on the hardware capabilities 208 the response from the request for object details 205 initiate new actions. If the mobile device is capable of voice communications, then the option to dial a phone number from the object detail is available. In an exemplary demonstration, if the mobile device is capable of data storage then such capability is enabled.

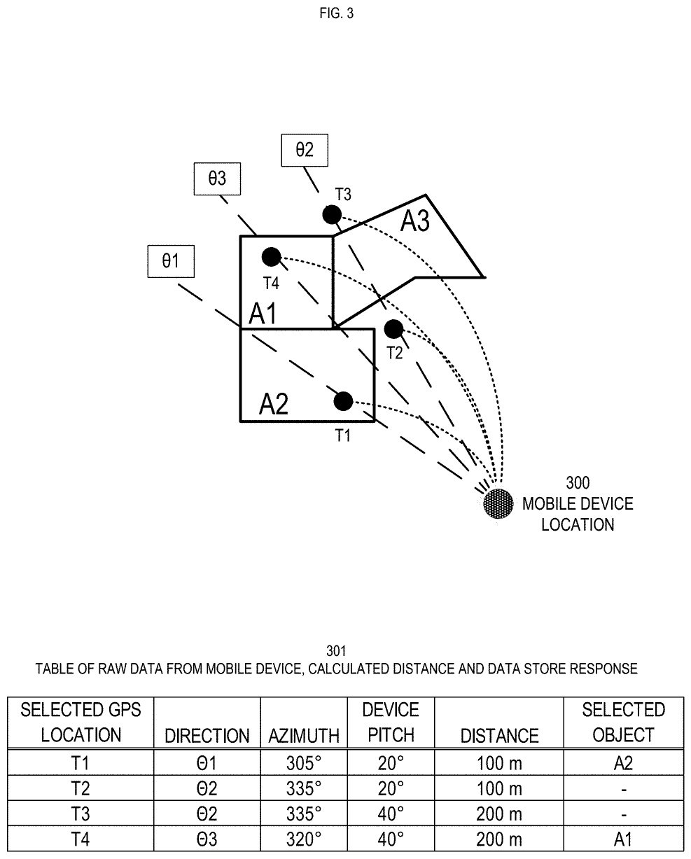

FIG. 3 is an embodiment of an implementation. From the mobile device location 300, the mobile device can be pointed in any direction. In this exemplary demonstration, there are three examples, Θ1, Θ2 and Θ3. There are three objects A1, A2 and A3. The mobile device requests four times details of objects at location T1, T2, T3 and T4. The locations are selected by the intersection of the azimuth vector and the range arc. The curve from the mobile device location represents the trajectory based on the mobile device pitch. The mobile device can have any pitch from 0 to 90 degrees. This exemplified by demonstrating the pitch of T1 and T2 at 20 degrees and the pitch of T3 and T4 at 40 degrees. In this embodiment T1 falls within the area of A2 and T4 falls within the area of A1. T2 and T3 fall outside the intended object. The data store response for T1 are the details of A2. The data store responses for T2 and T3 is that no object is found at that selected location. The data store response for T4 are the details of A1.

The table 301 is an exemplary demonstration of the representative data from the mobile device, software algorithms and the data store. Raw data from the mobile device, azimuth and pitch is used in an algorithm to calculate the distance and the GPS position. The request to the data store includes GPS coordinates of the selected location. The data store responds with details where objects are identified.

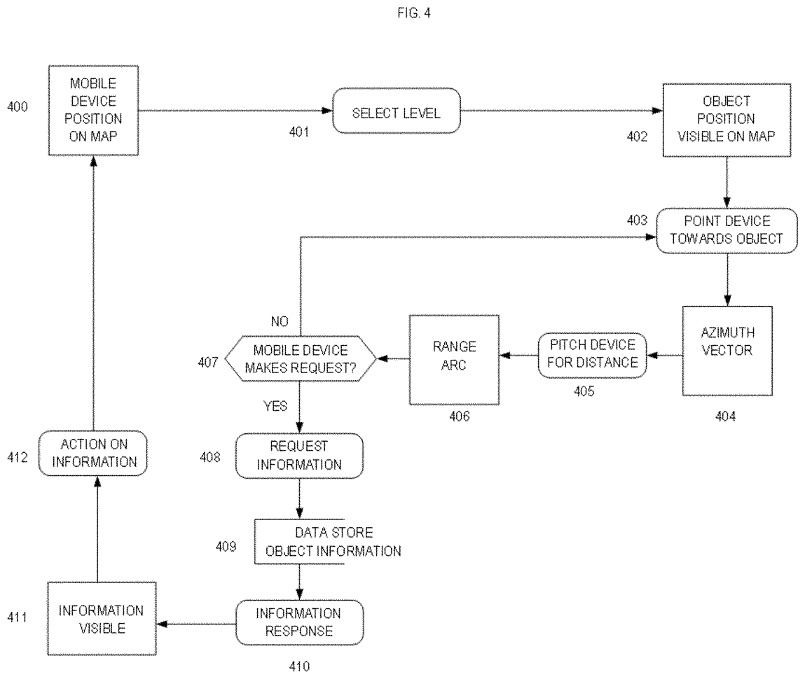

FIG. 4 is a block diagram illustrating how an object is selected for information. The map in the response sent 112 is displayed on the mobile device and the mobile device position 400 is identified on the map. The map from the data store response is displayed at a scale roughly analogous to the line of sight. If the object to be selected is not visible the map scale is adjusted 401. If the object is in the mobile device line of sight, this facilitates an accurate azimuth vector. The object is required to be visible on the map 402 for an accurate range arc. With the mobile device and the target object position on the map, the mobile device is pointed in the direction of the target object 403. From any direction and the device at any pitch an accurate azimuth vector from the mobile device, emanates outward. If the azimuth vector does not intersect the target object, the mobile device direction is revised until the azimuth vector intersects the target object. To identify exactly the location of the target object, the pitch of the mobile device 406 is intersects the target object. If the range arc does not intersect the target object, the pitch of the mobile device is revised until said range arc intersects the target object. While there is no request for details 407, the azimuth vector and the range arc continue to reflect the updated mobile device direction. When the mobile device requests 407 information on the object at the intersection of the azimuth vector and the range arc, a request is created. Optionally even when the mobile device creates a request, the azimuth vector and the range arc continue to reflect the direction and pitch of the mobile device.

The mobile device creates a request 408 including the GPS location of the intersection of said vector and arc. The algorithm to determine the location of the selected GPS location uses the azimuth vector for degrees, the range arc for distance and the map scale. The distance is calculated from the pitch of the mobile device and the map scale to determine the distance from the mobile device. Using trigonometry, the distance and the angle, using the azimuth vector, from the mobile device is used to determine the Cartesian point. The Cartesian point is the selected GPS location. This Cartesian point, in GPS location format is messaged to the data store. The data store 409 holds object information. Each object has a bounding box in GPS coordinates and a series of points in GPS coordinates to recreate the object as a polygon. The bounding boxes are indexed for rapid identification. Using Algebra, bounding boxes that might contain the selected GPS location are checked to establish firmly whether or not the selected GPS location is within the polygon created by series of data points. If the selected GPS location is within the polygon, then the object details are included in the data store response.

The data store returns a response 410 with information on objects identified. If no object is at the location the response includes a message as such. The response is received by the mobile device and process for display. Where the mobile device was request 407 is asynchronous, the data processing is processed on background thread. The details of the selected object are available on the mobile device. In accordance with available secondary information and hardware capabilities 412, the data can be acted on. An exemplary demonstration is how if the response includes person names, these names can be queried in publically accessible social media sites FIG. 2 207 such as Facebook, Twitter and LinkedIn. A business name can be queried in publically accessible social media sites such as Google, Yelp and Angie's List. The provided data can also link to proprietary data such as health records, financial records and criminal records. If the mobile devise supports text messaging or telephone calling FIG. 2 208 and applicable information is provided such as Email or phone number, the secondary action is possible. Secondary information requests are based on the information returned from the data store 409 on the selected object 407. The process of requesting information from the data store on selected objects is repeatable indefinitely.

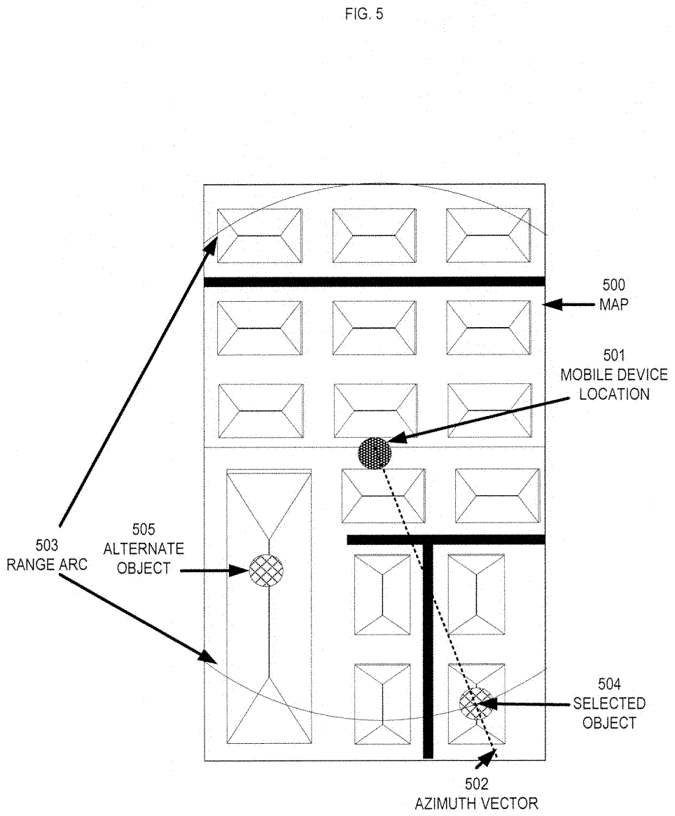

FIG. 5 is an embodiment of an implementation. It is an explanatory diagram illustrating an image and dynamic object movement. It starts with receiving a map FIG. 1 113. The same map 500 is displayed on the screen of the mobile device. The operator location 501 is marked on the map for reference. The azimuth vector 502 points in the direction that the mobile device is pointing. Based on the mobile device pitch and the map scale 503 there is the range arc depicting the distance at any azimuth. The intersection 504 of the azimuth vector and the range arc is the location of the object being selected. In an exemplary demonstration, an alternate object 505 is displayed on the map.

The map 500 is from the response sent FIG. 1 110. The map of objects FIG. 1 113. The GPS location of the mobile device is read and the map is centered on the mobile device. It is possible move the map and zoom in or zoom out on the scale of the map. The mobile device location moves with the map. It is possible to move the map such that the mobile device location 501 is off the visible map 500. The mobile device location 501 is a visual reference point for the operator to logically understand how azimuth is calculated from the direction that the mobile device is pointing, but the calculation will remain accurate and any part of the vector on the map will be displayed. As an exemplary demonstration, the vector may be displayed and is correctly calculated even when the vector is not displayed.

As an alternate exemplary demonstration, the map 500 will automatically zoom out if the mobile device moves off the map. When the mobile device

At all times the display representation of the mobile device location 501 reflects the GPS location on the map. The location is marked on the map 500 as the reference for calculating the azimuth of the object to be selected. The mobile device location 501 is the position from which the range arc emanates. As the GPS location of the mobile device changes, the mobile device location is updated on the map. When the mobile device location is off the map 500 the azimuth continues to be based on the mobile device position. If the azimuth vector 502 crosses the map, that portion of the range arc can be displayed. To maintain the mobile device location visible on the map, it is necessary to zoom out the map. When the GPS position of the mobile device is again within the parameters of the map, it will be displayed at the correct GPS location on the map.

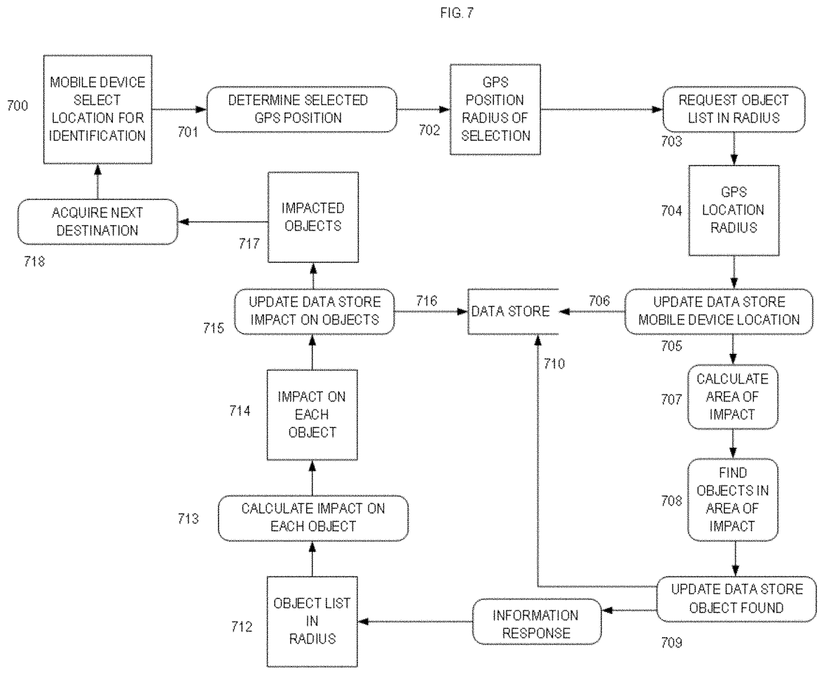

The azimuth vector 502 indicates the line on which an object may be selected. This corresponds with the direction that the mobile device is directed. This is analogous to pointing a remote control and the object to be controlled. The azimuth vector emanates outward from the mobile device location 501 depicted on the map. As the mobile device is rotated towards different directions, the azimuth vector reflects the movement with the azimuth vector pointing the direction of the mobile device. Any object intersecting or within a specified delta of the azimuth vector may be selected as the object for identification. In this exemplary diagram the operator may point directly at the object to be selected. The azimuth vector indicates if the intended object is on the path for selection. The selected object may be in motion and the mobile device must follow the selected object until the request for targets in radius FIG. 7 703. At any map scale the operator has the option to select an object by pointing in the direction of the object as depicted in the top down view of the map 500. Where the scale is beyond the line of sight, the operator identifies the object to select from the map and points the mobile device in the direction of the object to select.

The range arc 503 is a calculation based on the map 500 scale and the mobile device pitch. On initial display of the map the scale is a proportion to the mobile device pitch. An exemplary demonstration is that the initial position of the mobile device location 501 is centered in the map. The closest map edge is one mile. One mile is mapped to a defined pitch, for example, forty-five or ninety degrees. The scale is mapped to the pitch such that the pitch ratio is the ratio away from the mobile device location. Zoom in or zoom out of the map does not change the original ratios. The ratios remain fixed until intentionally updated. The center of the range arc remains in the center of the mobile device location. As the mobile device moves, the center of the range arc moves and the entire range arc and the range arc is updated with the center reset on the mobile device.

The selected object 504 is the intersection of the azimuth vector 502 and the range arc 503. The GPS location is at the center of the intersection. Any changes of the mobile device location, mobile device direction or pitch requires a recalculating of the distance from the selected object GPS location. If the selected object is in motion, then the mobile device must track the selected object with any change in direction or distance. At a request for a target list in the radius FIG. 7 703 the intersection of the azimuth vector and range arc is transmitted to the data store. If the selected object is in motion and moves outside the area of impact between the mobile device request and the data store selection, the selected object is not identified. At the time of the mobile device request from the data store, the position of the mobile device is included in the request FIG. 7 704. The location of the mobile device FIG. 7 705 is transmitted to the selected object and the selected object receives notification that an attempt was made to learn information on the said object. The information about the selected object that is transmitted to the mobile device is also submitted to the selected object. At the same time the selected object may adopt the role of mobile device and using an azimuth vector and range arc request information from the data store on mobile device 501. Any information transmitted to the selected object by the data store is also transmitted to the mobile device.

The alternate object 505 is aware of the GPS location of the mobile device and the selected object at the last identified location. When the mobile device requests information on the selected object, the location of the mobile device is also transmitted to the alternate device. The position of the mobile device is updated on the map 500. It is the alternate object's prerogative to adopt the role of mobile device and using an azimuth vector and range arc request information from the data store on mobile device 501. Any information in the response to the alternate object from the data store FIG. 7 715 is transmitted also to the mobile device 501. The position of the alternate object is updated in data store FIG. 7 706 and the position is transmitted to the mobile device 501 and the selected object 504. The updated location of the alternate object 505 is repositioned on the map 500.

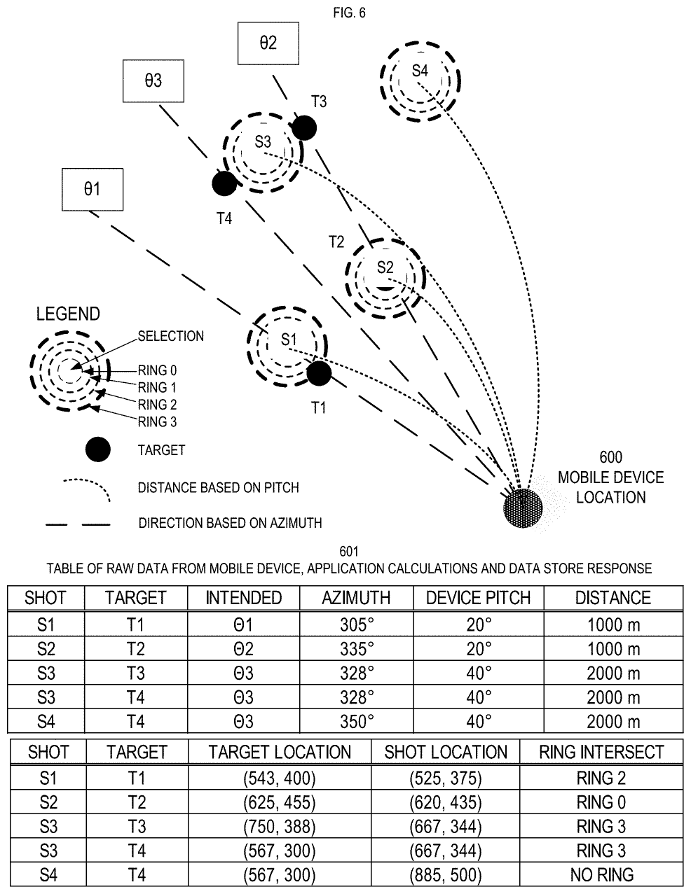

FIG. 6 is an embodiment of an implementation. From the mobile device location 600, the mobile device can be pointed in any direction. In this exemplary demonstration, there are three examples, θ1, θ2 and θ3. There are four objects, targets, T1, T2, T3 AND T4. The mobile device requests four times details of objects at location, shot, S1, S2, S3 and S4. The locations are selected by the intersection of the azimuth vector and the range arc. The curve from the mobile device location represents the trajectory based on the mobile device pitch. The mobile device can have any pitch from 0 to 90 degrees. This is exemplified by demonstrating the pitch of S1 and S2 at 20 degrees and the pitch of S3 and S4 at 40 degrees. In this embodiment S1 falls beyond T1, S2 falls on T2, S3 falls between T3 and T4 and S4 falls wide of T3. Each Sn has at least one radius of selection. In this embodiment an S has four rings. Each ring, 0 through 3 provides different quantity of details of any object within the radios. The data store response for S1 are the details of T1. Ring 2 of S1 is the first ring to contact T1 therefore the level of detail provided level 2. In this embodiment, rings closer to the center of S provide more information. Ring 2 provides more information that Ring 3, but less that Ring 1. S2 is on T2. This is Ring 0 and provides the most information on the selected object. S3, between T4 and T3 have Ring 3 intersecting both objects. Information on both objects are provided, but at Ring 3 level, the least amount of information.

The table 601 is an exemplary demonstration of the representative data from the mobile device, software algorithms and the data store. Raw data from the mobile device, azimuth, pitch and selected GPS location. The top table is representative of the data provide by the mobile device. Distance is calculated in an algorithm to calculate the distance based on azimuth, pitch and map scale.

The bottom table is sample data sent to the data store. Target location, T, is known in the database. Shot location, S, is provided by the mobile device. Beginning with the outmost ring FIG. 7 712, all objects in the ring are identified. From those objects identified, the algorithm identifies which rings intersect S FIG. 7 714. The innermost ring intersecting S is the level of details provided on the object in the response FIG. 7 717. All targets T are updated on the position of the mobile device 600. From θ1, the mobile device receives information on T1 specified from Ring 2. T1 receives a message that Ring 2 details about itself have been provided to the mobile device. From θ2, the mobile device receives information on T2 specified from Ring 0. T2 receives a message that Ring 0 details about itself have been provided to the mobile device. From θ2 there is no information on T3 because T3 is not within the radius of the outmost ring, Ring 3. S3 which falls between T3 and T4 includes both targets on Ring 3. The mobile device receives information on T3 and T4 specified from Ring 3. T3 receives a message that Ring 3 details about itself have been provided to the mobile device. T4 receives a message that Ring 3 details about itself have been provided to the mobile device. No information has been shared between T3 and T4. From θ4 there is no target with the outmost ring and no information is returned to the mobile device except that no object was identified.

FIG. 7 is a block diagram illustrating how an object is selected for information and how the data store maintains information on the location of each object. The map in the response sent FIG. 1 113 is displayed on the mobile device and the mobile device position is identified on the map. Each object that can be identified 700 is displayed on the map at the last known location. The GPS location is calculated 701 based on the map scale and the distance and direction from the mobile device. The radius of impact for each ring is determined based on rules. The number of rings and the radius 702 can be set using the mobile device or set by an algorithm. A message is sent to the data store containing the following information:

Location of the Mobile Device in GPS Coordinates.

Target location as a function of the intersection of the azimuth vector and the range arc. Location of the target is in GPS coordinates.

Optionally, a list of rings where each ring is including the radius from the center of the target. In an embodiment of an implementation, the radius can be identified as any GPS coordinate on the ring. If no ring is provided, there is a default, ring 0 on the data store.

The request created 702 is sent to the system as a request 703 for all objects that fall within the distance of the outermost ring. The system determines the area the outermost area 704 of for calculating what objects to be identified. The center of the area is the updated GPS location of the mobile device. The system 705 updates the data store of the GPS location of the mobile device. The data store 706 has the updated position and broadcasts the updated position to all objects known in the data store. Using the updated GPS location of the mobile device, the system calculates the area of impact 707 for each ring.

In an embodiment of an implementation, the process of identification 708, begins with the largest ring and identifies all objects in the ring. Of the objects identified, each is compared if in the subsequent inner ring. This process is continued until identification of any objects in Ring 0. Each object identified is associated 709 with ring in which it is located and provided to the data store. The data store 706 retains the information:
Mobile device requesting information
Objects found with the rings.
The ring the object is located in.
Each object located is messaged 710 that it has been identified. The message includes
The location of the mobile device at the time of the mobile device request
The ring level of the information provided to the mobile device
The information provided to the mobile device.

All objects, even objects not identified in the mobile device ring, are updated with the location of mobile device. In an alternate embodiment of an implementation additional information can be provided to some or all objects. The information might include partial information messaged to objects identified.

The system receives information on the targeted objects 711. Each object has a history of being identified in a ring. The latest identification is added to the history 712 and an algorithm determines any impact on the object. In an embodiment of an implementation 713, an object has a health level. Previously the mobile device has identified the object and each identification reduces the health of the object. The impact assessment 714 is messaged to each object identified. The impact might include degradation of ring radii, reduction in maximum range of the range arc or a period of delay before the object can take the roll of mobile device.

The impact is retained in the data store 706. This data is used in any future object identification to recreate the history if identifications.

Each identified object is notified 715 with the resulting the implication of being identified at the specified ring. Any impact on the object is described to the object and the resulting impact is controlled by the system. At any time that an object assumes the role of mobile device, a precondition of limitations imposed by previous identifications is placed on said object. In an alternate embodiment, some or all objects may be messaged on the impact on the objects identified.

On completion of identification of objects 716 the mobile device is updated with the impact of the previous selected GPS position and adjusts the azimuth vector and range arc to acquire more object identifications. 717 is the on screen identification of objects impacted. 718 is the initiation of the process again.

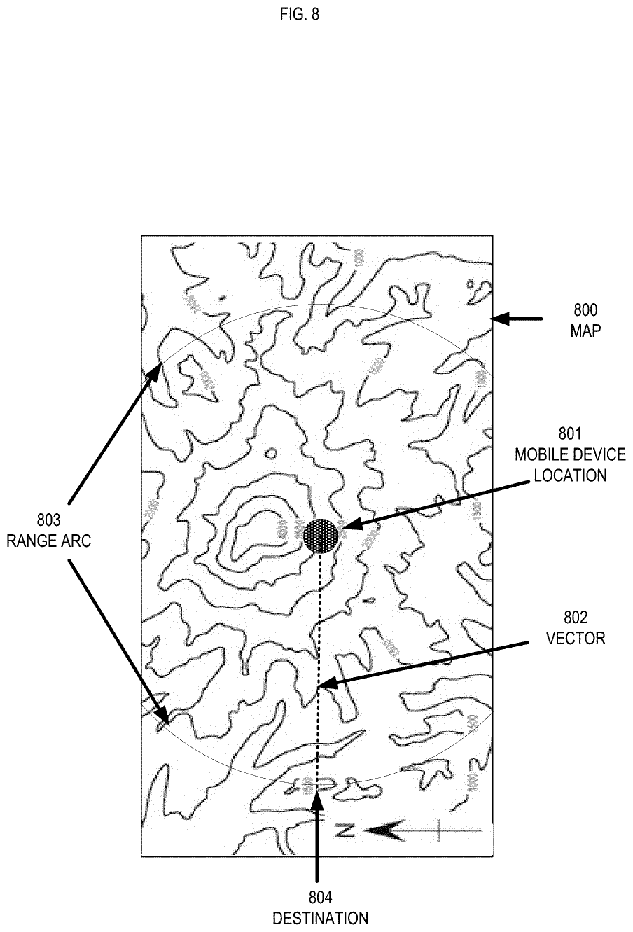

FIG. 8 is an embodiment of an implementation. It is an explanatory diagram illustrating an image and destination selection. It starts with receiving a map FIG. 1 113. The map 800 is displayed on the screen of the mobile device. The operator location 801 is marked on the map for reference. The azimuth vector 802 points in the direction that the mobile device is pointing. Based on the mobile device pitch and the map scale 803 there is the range arc depicting the distance at any azimuth. The intersection 804 of the azimuth vector and the range arc is identification of the distance to measure. In an exemplary demonstration, the mobile device can be pointed at the destination. Visual inspection of the map 800 on the device references the line from which distance will be measure. The azimuth vector is useful for determining more precisely the position of the distance arc, but an accurate distance arc suffices. The destination 804 is measured from the mobile device location to the range arc.

The map 800 is from the response sent FIG. 1 110. The map of objects FIG. 1 113. The GPS location of the mobile device is read and the map is centered on the mobile device. It is possible move the map and zoom in or zoom out on the scale of the map. The mobile device location is moved with the map. It is possible to move the map such that the mobile device location 801 is off the visible map 800. The mobile device location 801 is a visual reference point for the operator to logically understand from where the distance is calculated.

At all times the display representation of the mobile device location 801 reflects the GPS location on the map. The location is marked on the map 800 as the reference for calculating the distance to the destination. The mobile device location 801 is the position from which the range arc emanates. As the GPS location of the mobile device changes, the mobile device location is updated on the map. When the mobile device location is off the map 800 the range arc remains visible. To maintain the mobile device location visible on the map, it is necessary to zoom out the map. When the GPS position of the mobile device is again within the parameters of the map, it will be displayed at the correct GPS location on the map.

The azimuth vector 802 is a convenience to more accurately place the range arc. This corresponds with the direction that the mobile device is directed. This is analogous to pointing a remote control and the object to be controlled. The azimuth vector emanates outward from the mobile device location 801 depicted on the map. As the mobile device is rotated towards different directions, the azimuth vector reflects the movement with the azimuth vector pointing the direction of the mobile device. In this exemplary diagram the operator may point at the destination or ignore the azimuth vector.

The range arc 803 is a calculation based on the map 800 scale and the mobile device pitch. On initial display of the map the scale is a proportion to the mobile device pitch. An exemplary demonstration is that the initial position of the mobile device location 801 is centered in the map. The closest map edge is one mile. One mile is mapped to a predefined pitch, for example, forty-five or ninety degrees. The scale is mapped to the pitch such that the pitch ratio is the ratio away from the mobile device location. Zoom in or zoom out of the map does not change the original ratios. The ratios remain fixed until intentionally updated. The center of the range arc remain in the center of the mobile device location. As the mobile device moves, the center of the range arc moves and the entire range arc and the range arc is updated with the center reset on the mobile device.

The range arc represents the distance to measure. To determine the straight line distance, modify the pitch of the mobile device until the range arc 804 is over the destination. All points on the range arc are equidistant from the mobile device location and any point on the range arc is representative of the straight line distance.

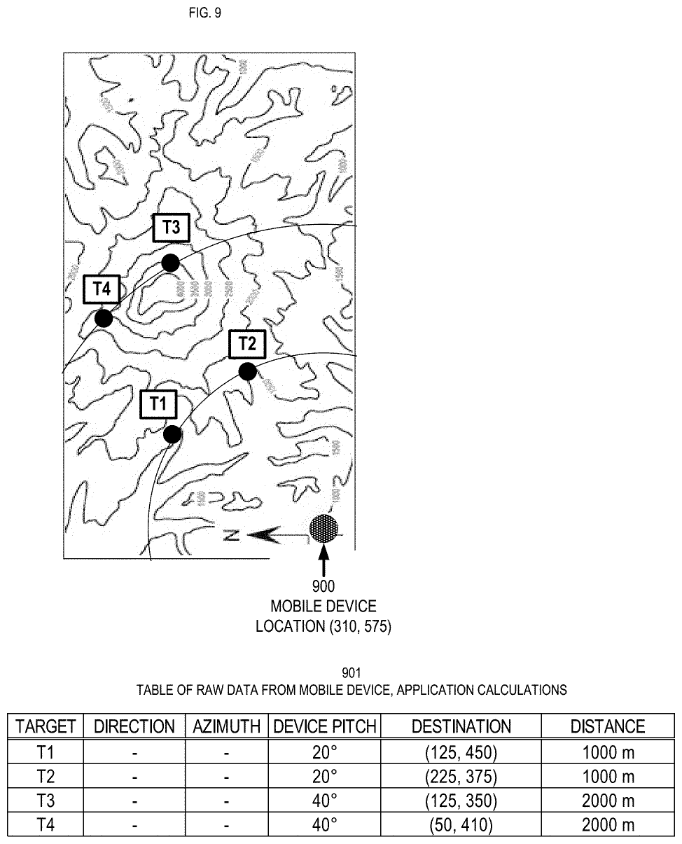

FIG. 9 is an embodiment of an implementation. From the mobile device location 900, the mobile device can be pointed in any direction. There are four objects, targets, T1, T2, T3 and T4. T1 and T2 are equidistant form the mobile device location as the range vector crosses both targets on the same range arc at this pitch. T3 and T4 are equidistant from the mobile device location as they are intersected by the same range arc at the same pitch. The mobile device can have any pitch from 0 to 90 degrees. This exemplified by demonstrating the pitch of S1 and S2 at 20 degrees and the pitch of S3 and S4 at 40 degrees.

The table 901 is an exemplary demonstration of the representative data from the mobile device and software algorithms. Raw data from the mobile device, selected GPS location. The device pitch is representative of the data provide by the mobile device. Distance is calculated in an algorithm to calculate the distance based on pitch and map scale. The algorithm makes a maximum range on the map, initially near the shorter edge from the map center position. That is assigned the maximum pitch, a predefined value between 1 and 90 degrees inclusive. Typical default values are 45 degrees or 90 degrees. T1, T2, T3 and T4 are demonstration destinations. Direction and corresponding azimuth vector is ignored in the calculation. The azimuth vector may be displayed as an aid to more accurately place the range arc on the destinations. Distance is displayed by the device pitch and a corresponding range arc. As the arc is a circle from the center of the mobile device GPS location, all distances on the range arc are equidistant from the mobile device. In this exemplary demonstration the destination is a simulated calculated GPS location. Distance is indicative that any point on the range curve is equal distance from the mobile device.

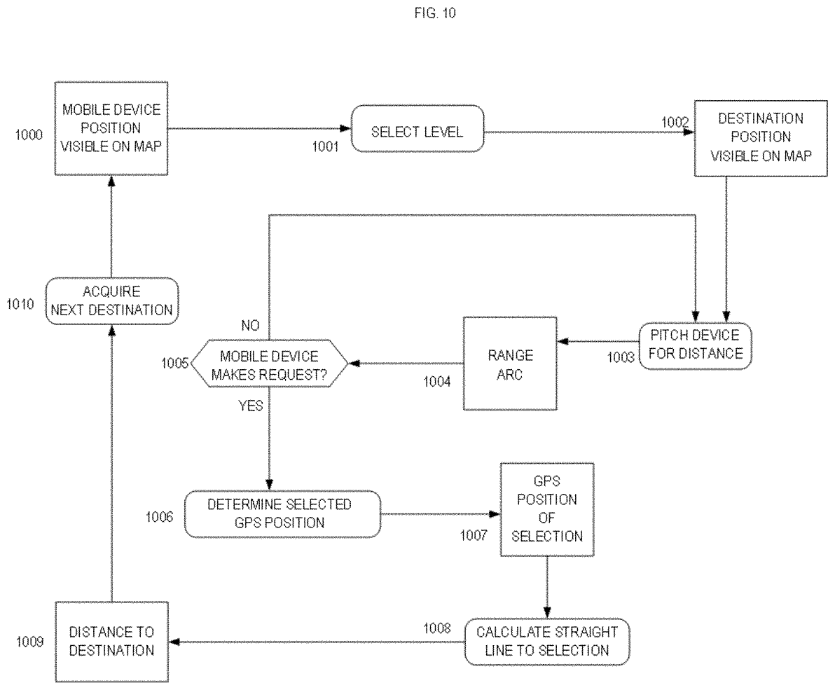

FIG. 10 is a block diagram illustrating how a location is selected for distance measurement. The azimuth vector is not required and not utilized. Using a predefined azimuth vector, any compass value between 0 and 359 degrees is used to create the intersection with the range arc. The intersection is for determining a GPS coordinate on the range arc. With the GPS location of the mobile device 1000 and any GPS location on the range arc 1004, the straight line distance is calculated using Algebra.

The mobile device requests from the GPS sensor the current location coordinates and centers the map on the location and a marker signifying the mobile device location 1000 on the map. The map level is selected 1001 using the mobile device. The selected level sets the maximum range. For best accuracy the level is the smallest measurement that includes the destination 1002. The larger the measurement, the more difficult it is to precisely set the range arc. As an exemplary demonstration to address this problem, a magnification of the selected location more visually displays the location of the range arc relative to the destination.

Using the mobile device pitch 1003, as in previous demonstrations FIG. 4 406 and FIG. 7. 701 is used for displaying the range arc. With the range arc 1004 overlaid on the map, the range arc can be positioned on the destination. At large distances, the thickness of the range arc displayed makes accurate identification of the destination more difficult. To alleviate the condition, a magnification in a split screen depicts more detail of the selected area. As an exemplary demonstration the area for magnification can be selected by touching the screen of the mobile device or dragging a virtual magnification glass to over the area of interest. With the reintroduction of the azimuth vector FIG. 4 404, the intersection of the azimuth vector and the range arc is magnified. The magnification enables the mobile device to more accurately select the destination to measure.

Until the mobile devices makes a request 1005 the pitch is calculated and the range arc redrawn with the magnification following the redrawn range arc. On requesting distance, the application calculates a GPS coordinate on the range arc. Any virtual azimuth vector is appropriate 1006, as an exemplary demonstration, GPS coordinate is due north at compass reading of 0 degrees. The intersection of the virtual azimuth and the range arc 1007 are converted to a GPS location

With any two GPS coordinates 1008 the calculation of the straight line distance is calculated. As an exemplary demonstration, the implementation is by using right triangle measurements. By the right triangle measurements, the measurement of the hypotenuse is the straight line distance 1009 to the destination. The mobile device is reset 1010 to acquire the next destination. The position of the mobile device 1000 is verified using the GPS sensor. As an exemplary demonstration, the location of the mobile device can be updated in real-time, but practical difficulties in adjusting the pitch to select a destination while moving is impractical.

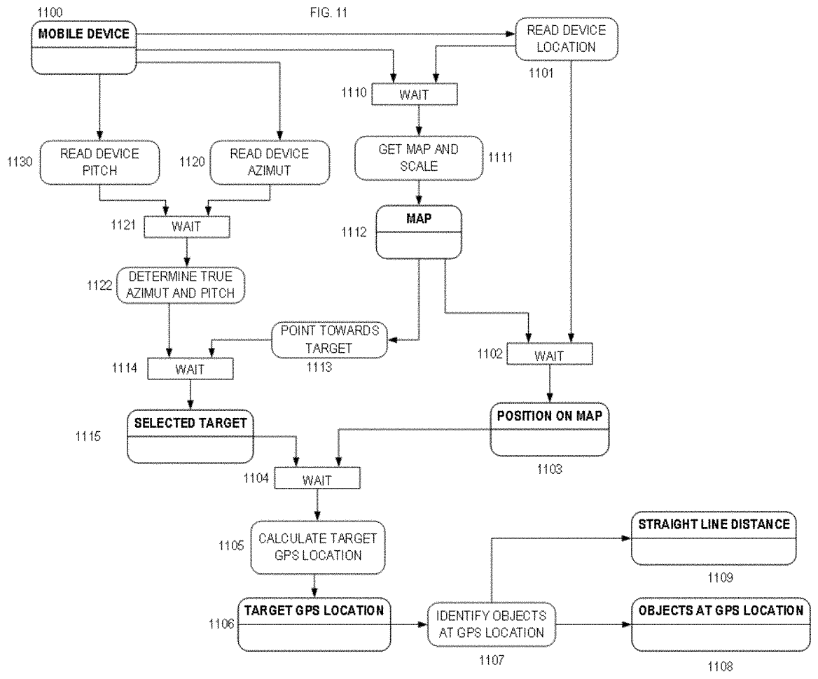

FIG. 11 is an embodiment of an implementation. The mobile device 1100 initiates four actions, in any order or in parallel. The four actions are 1101, 1110, 1120 and 1130. At some future time in the process the system will wait for the independent actions to complete. These waiting points are 1102, 1104, 1110, 1114 and 1121. In the event one of the processes does not complete, a target GPS location 1115 cannot be determined and the activity of locating an object is halted. The mobile device 1100, in any order, or parallel, makes a request from the device GPS sensor 1101 for the most accurate possible, current GPS location. The mobile device prepares a request from a map service to provide a map based on the results of the GPS location. The mobile devices make additional requests for device sensor values of direction 1120 and pitch 1130.

1101 is the reading of the device location. It is premised on an ability for the device to determine its location from GPS satellites. If the device does not have a GPS sensor, then a message is sent from the application to the device indicating that no further processing is possible. When there is a GPS sensor additional factors may prevent providing a valid GPS location. A weak battery in the mobile device may limit device usage to only the core, critical functions. In this event, notification is provided to the mobile device as such and to charge the device. The mobile device may be in a location where insufficient GPS satellite readings result in an inconclusive GPS location. This can happen when the mobile device is indoor. It can also happen outdoor where building, trees or other obstacles block a direct line between GPS satellites and the mobile device. In this event of an inconclusive GPS location, the mobile device receives a message that satellites reception is being blocked and to locate to a position where a sufficient set of satellites can triangulate on the mobile device location. There are further instances where the GPS location is incorrect, based on a previous reading. Mobile device GPS sensor update frequency can be controlled by the mobile device. When there is an existing GPS location, an update by the sensor is requested. If the request fails because of insufficient GPS satellite readings, the existing GPS location is used. It can happen that the existing location is incorrect. Depending on the map scale, it may be observable on the mobile device. Calculations are based on the existing GPS location and in this scenario the results returned may be incorrect. GPS sensor reading requests are as often as the mobile device settings permit. On an update, the current position of the mobile device is updated on the map. There are instances of abnormal behavior, the GPS location not displayed on the map because the GPS location is outside the map. A new map is requested and the process resumes.

1110 is the preparation of a request for a map and based on the GPS location 1101 of the mobile device and the prescribed scale. Scale may be set in the mobile device or calculated based on device screen size and activity the mobile device is requesting to fulfill. If no GPS location 1101 is received in a predetermined period of time, measured in seconds, then a message is provided to the mobile device 1100 as such and further operations are cancelled.

A new request for an updated map may be required after any target is selected for identification. The update request is predicated by a comparison of the current GPS location read from the GPS sensor in the mobile device and the GPS position used in the previous target selection. Where the map scale and the new GPS location makes selection of the next target for identification, the map is replaced with an updated map and the mobile device position set on the updated map. GPS location updates of the mobile device may occur several time a second. This make it infeasible to update the map based on the updated GPS location of the mobile device. In this scenario the GPS location of the mobile device is updated on the map. Where the map scale is high detail and the mobile device distance between GPS location readings is significant, the mobile device GPS location could move off the map.

1120 is the process of reading and calculating the true azimuth. There may be multiple different sensors to determine the device azimuth 1120. If there are no azimuth sensors, then functionality is limited to reading straight line distances. It is not possible to select targets for identification. If the compass sensor of the mobile device is used, the direction reading will be incorrect for all readings except when the mobile device is parallel to the Earth. An algorithm to compensate for the mobile device pitch 1130 is necessary to correctly identify the direction the mobile device is being pointed. Mobile device roll has not impact on the accuracy of the direction reading. Where other sensors are used, such as the acceleration measure, a different set of algorithms are necessary to compensate for the mobile device pitch. A

1130 is the process of reading and calculating the true pitch. There may be multiple different sensors to determine the device pitch 1130. If there are no pitch sensors, then functionality is limited to a default distance. Where pitch can be calculated from other sensors, such as an acceleration measure, an algorithm converts the measurements to a pitch. Pitch is independent of direction. It is not required to compensate pitch for different directions, except possibly at the Earth poles.

In an embodiment of this example where there is no pitch sensor 1130, the mobile device can request objects on the azimuth vector at a pre-determined location. An emergency services vehicle operating in a built up area can select a residential building from the street. Point the mobile device at the target building and request information. The pre-determined distance can be premised on typical street width and typical plot sizes. Accurate selection of target objects is limited to the range set. This reduces accuracy of correctly selecting an object, but is functional is some scenarios.

1121 is constantly changing and the mobile device direction and pitch change. Different sensors may be used to determine direction and pitch. Each cycle of refreshing the values of the direction and pitch initiates a request to calculate the true azimuth and pitch 1122.

1122 is the modification of the azimuth to compensate for the pitch. Algorithms for calculating the true azimuth, compensating for pitch, are generally available. In an embodiment of an example where the pitch sensor is mapped to another value as where maximum distance is forty-five degrees and values above 45 are a mirror image of the first 45, up to 90 degrees.

1102 controls the condition of having both a GPS location and a map to display. If no GPS location 1101 and no map 1112 is received in a predetermined period of time, measured in seconds, then a message is provided to the mobile device 1100 as such and further operations are cancelled. If the GPS location is received and the map is not, then a message indicating no map is available is returned to the mobile device 1100. With both a map and a GPS location, both are displayed on the mobile device

1103 is the calculation of the best map scale where the mobile device is centered on the map and any pre-defined targets are also displayed. When the targets are static the map scale is as small as possible to encompass all targets. When the targets may move, the scale is calculated to provide reasonable movement away from the mobile device and remain visible on the map.

1104 waits for the mobile device position and the location of the selected target. While the mobile device has no selected target the mobile device is capable of changing azimuth vector and by pitch modifying the range arc. At the time when a location is selected 1115 as a target then begin calculating the distance from the mobile device to the target.

1105 requires information about the map and the mobile device screen. The mobile device has the width of a pixel, the size of the screen in inches and the number of pixels displayed on the screen. This results in the number of pixels per inch. In an embodiment of an example if the map scale is 1:5000, one inch on the screen equals 5000 inches on the map. Where the screen resolution is 72 pixels per inch 72 pixels represents 5000 inches on the map. The location of the mobile device is known in GPS position and pixel location. The target is known in pixel location. The distance is calculated as the hypotenuse of a right triangle where in pixels (mobile X location−target X location) squared+(mobile Y location−target y location) squared equals the hypotenuse squared. The square root is the effective pixel distance between the mobile device and the target device. Where 72 pixels equals 5000 inches on the map, the ratio of hypotenuse pixels/72=map distance/5000. With the map distance calculated and the azimuth is known, the GPS location of the target is determined with trigonometry. Algorithms for calculating the latitude and longitude of the target from the mobile device are generally available.

1106 is the unique global GPS location for the target.

1107 is a request from the data store to provide a list of all objects at the GPS location provided. Additional nearby objects can be identified where the GPS location is the center of a circle and the radius is the size of the surrounding area to search in the data store.

1108 is the response from the data store of all objects identified at the prescribed GPS location, or near the GPS location as specified.

1109 is the hypotenuse of the right triangle calculated in 1105 is the straight line distance.

1111 is the request for a specified map of size and scale. There is a default scale, typically no more than one kilometer from the center point on the map. The default is used when no predefined targets have been identified. If a target has been identified, then the scale is small enough to encompass the mobile device location and the target. In an embodiment of an example of predefined targets, multiple mobile devices on the same Wi-Fi are aware of those surrounding mobile devices. Where the target of each mobile device is other mobile devices a smallest bounding circle is calculated and this is the predefined scale encompassing all targets.

1112 is the response from the map server and displayed on the mobile device. The map is centered on the mobile device and any pre-identified targets are marked on the map. In the embodiment of the example in 1111, as each mobile device will be centered on the map and all pre-defined targets are displayed on said map, the map scale on each mobile device map be different. Results of target selection remain consistent as the device pitch is a function of the map scale on that specific device. In cases where a mobile device has a significantly larger scale to accompany all pre-defined targets, it will be more difficult to accurately select a distant target. This is consistent behavior with unguided real world trajectories.

1113 represents the azimuth vector to define at what compass direction the selected target is.

1114 is the visual representation of selecting a target. The map is displayed on the mobile device. As the mobile device points at different direction, the azimuth vector displays on the map, the direction of selection. As the mobile device points at the target, the azimuth vector crosses the target. As pitch is converted to distance, a range arc on the map depicts the intended range. Where the azimuth vector and the range arc intersect is the point of the selected target 1115.

1115 is calculating the visual representation 1114 on the map to a screen location. The result is the pixel point of the target. The calculation is based on the mobile device location, the distance arc and the azimuth vector. The distance arc is a manifestation of map distance to screen pixels. The hypotenuse of the right triangle is the absolute value of distance arc at X,0 minus the mobile device X position in pixels. Using trigonometry, with one leg of the triangle in pixels, the distance identified by the range arc and the direction as identified by the azimuth vector, the Y position of the target, in pixels is calculated.

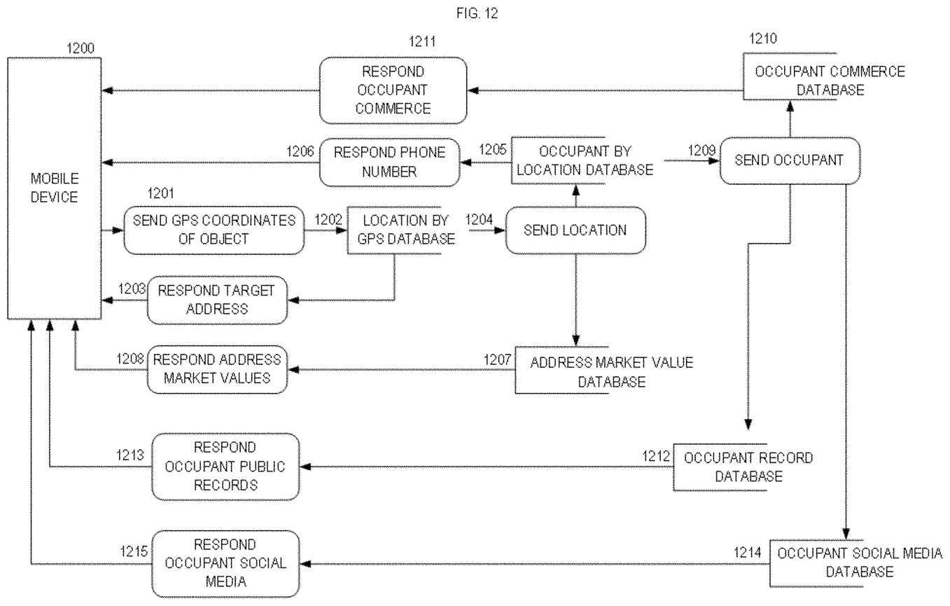

FIG. 12 is an activity diagram of an implementation. This represents the request and response from the data store. The mobile device 1200 initiate as request 1201 to the location data store 1202 with the GPS location. Details of the object are returned 1203. Based on the information about the object, secondary queries 1204 to a data store may result in additional information on the GPS location. A data store requires location parameters to send an accurate response. These requests and responses are chained where the response of one data store generates a request to another data store. In this embodiment of an implementation the GPS coordinates 1201 is sent in a message to the location GPS data store 1202. The location GPS data store identifies the postal address of the object at the GPS location. The address is included in the response 1203 to the mobile device 1200 to the mobile device and if the address is the required input, a request for information on the occupant at that address 1205. Occupant name and other information about the location is sent to the mobile device 1200 and the name is part of the request to data stores that use the name as a key to retrieving information. The name may be associated with a business 1210, public records such as criminal convictions 1212 and 1214 self-promoting information on social media such as Facebook™ and LinkedIn™.

1200 is the mobile device constructed with sensors and display screen. Internet connectivity is required to request data from the data store. In an exemplary construction of a mobile device, said device contains sensors for reading compass direction and sensors where pitch can be calculated. The screen to display the map is large enough for readability. Most mobile devices in production are constructed with these features. Most mobile devices in production include access to the internet for data access.

1201 is the construction of the request to the data store for location details. A data store specifies the format of the request including the GPS location. Where a GPS location has less than all significant digits, the GPS location is completed with trailing zeros. The request is constructed and sent via the Internet to the data store. Where there is no Internet connectivity, a message indicating Internet connectivity is required to request and retrieve data from the data store. Target identification is not possible. The message includes any identifiable reasons describing the status of connectivity sensors. When there is connectivity the request is routed to the data store in the Internet address included in the request message.

1202 decodes the message at the data store for GPS location and the radius of GPS locations to include in the identification. The GPS location provided represents the center of circle of objects for identification. Two bounding boxes, one outside the circle and a second within the circle. Any object determined by the two bounding boxes to be included in the response are identified. A response 1203 is returned to the mobile device. If the request from the mobile device includes a request for secondary information, the data store builds a request for the information based on the information retrieved in the location data store. This request is sent to a secondary data store 1204. As an alternate exemplary demonstration the response may be returned by the data store to the mobile device and the mobile device with the new information creates a new message according to the requirements of the secondary data store 1204.

1203 is the formatted response from the data store to the mobile device. The mobile device, knowing the configuration of the response message, identifies pertinent details in the message. As an alternate exemplary demonstration, details in the response are used to create another request to a different data store based on the information returned in the response.

1204 is similar to 1201 as it constructs a request to the secondary data store according the specified format. The request includes data not initially available from the mobile device, but available from the response of the first 1202 data store. A request may be sent to multiple 1205, 1207 secondary data stores simultaneously. The wish for information in secondary data stores is included in the request to the first data store.

1205 is similar to 1202. The secondary data store decodes the request and sends a response to the mobile device. The process is chained as the output of this data store 1205 includes the data not available directly from the mobile device. The output containing the new data is included in the input request to secondary data store. This can be continued where the new data found is the key to additional data in another data store. When the request includes a wish for supplemental information 1209 as 1202 the data store builds a request to secondary data store with the new information.

1206 is similar to 1203. The mobile device receives the response, knowing the source of the response. The response message is decoded with knowledge of the construction of the message.

1207 is similar to 1205.

1208 is similar to 1206.

1209 is similar to 1204. In this embodiment of an implementation, the supplemental request is sent to multiple data stores. The data store 1205 constructs unique requests as required by each data store. The request includes new information about the target that was found in the data store 1205.

1210 is similar to 1202

1211 is similar to 1203

1212 is similar to 1202

1213 is similar to 1203

1214 is similar to 1202

1215 is similar to 1203

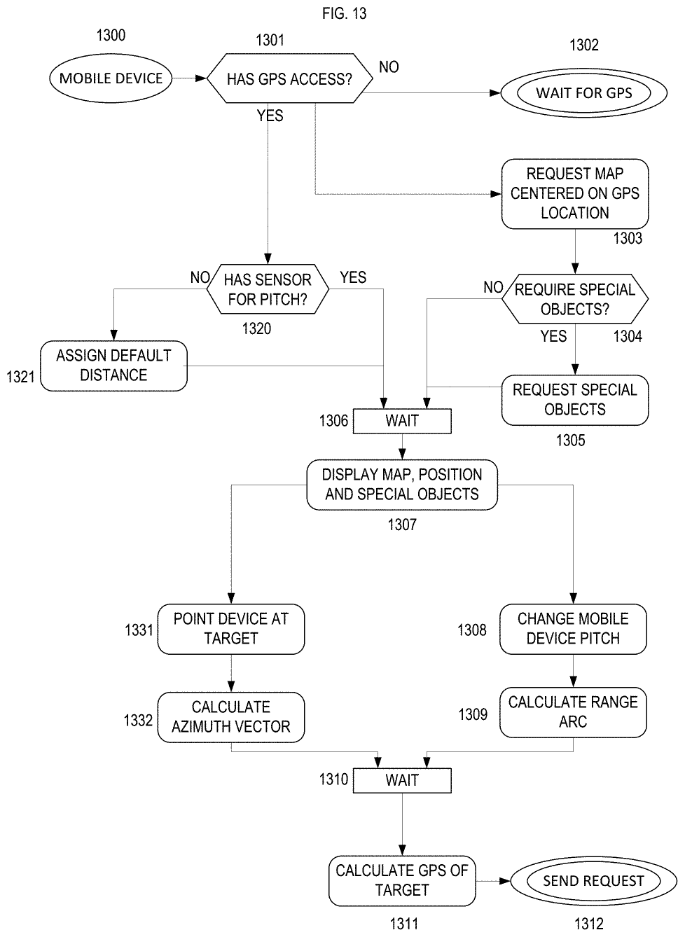

FIG. 13 is use case of an implementation. This represents pre conditions 1300, post conditions 1302 1312 and the steps demonstrating the interfaces between mobile device sensors and the map. GPS connectivity 1301 is a prerequisite to request information on an object. Sensor changes are reflected on the map for instant feedback on the location of the object selected for details.

1300 is a pre-condition that the mobile device has a screen to display the map and sensors to measure direction and pitch.

1301 tests if the GPS sensor exists, is enabled for the application and can receive a GPS location signal. With GPS access the appropriate map 1303 is requested. The GPS location of the mobile device may be incorrect by as much as one half kilometer. This is a limitation imposed by existing mobile device hardware. This test verifies that there is a GPS reading and cannot validate that the location identified is the actual location of the mobile device. Within the mobile device the GPS position is updated several times a second. With additional updates the, the location of the mobile device is more accurate.

1302 is when there is a GPS sensor but the sensor is not receiving data to request a map and locate the mobile device on the map. Many factors contribute to blocking GPS sensor reception. Once the factors have been resolved the GPS sensor will receive GPS location updates.

1303 is the request for a map centered on the GPS coordinates of the mobile device and the scale. An exemplary demonstration requires data connectivity between the mobile device and the remote data store. In another scenario the maps can be stored on the mobile device and used. In an embodiment of an implementation the fixed map would be an indoor shopping mall. Sensors in the mall triangulate the location of the mobile device. The floorplan of the mall is known and the floorplan is stored in the mobile device. Object selection is identical to the flow outlined in FIG. 11. The data store resides in the mobile device, the selected target can be identified and details about objects at the location are provided.

1304 refers to preconfigured objects on the map. An embodiment of an implementation is a multi-player game of laser tag. Each player is both a mobile device and an object for targeting. These objects are requested 1305. In an identification of object information at a GPS location, no special objects need to be requested.

1305 is an instance where special objects need to be placed on the map. The data store responds with the objects and each GPS location.

1306 waits for the condition where the map 1303, special objects 1305 and the range arc 1320 are available. This control will always continue to 1307. In an event that special objects are required but none are forthcoming, after a period of time, the process will proceed as though no special objects are required.

1307 utilizes the screen 1300 to display the map and any special objects. The GPS position of the mobile device is displayed on the map. After the map, objects and mobile device GPS position are displayed on the mobile device, the direction sensor 1331 and the pitch calculation sensors 1308 are used.

1308 responds to change in pitch. A pitch sensor or other sensors that can used to calculate the pitch are the mobile device method to communicate distance from the mobile device.

1309 is the graphic display of the range as calculated from the pitch 1308. The range is displayed over the map as a circle around the mobile device. As the pitch changes, the circle radius becomes bigger or smaller. This guides the mobile device to set the distance of the target from the mobile device. As indicated in 1320, the absence of any method to determine the mobile device pitch results in a single, fixed distance from the mobile device.

1310 utilizes both the azimuth vector and the range arc to identify the location that the mobile device has selected. The point of intersection between the two is the point of selection. At very large map scales the width of the lines may visually result in ambiguity of precision on the mobile device. The mobile device selects the center of both lines as the actual position of the object selected.

1311 calculates the visual pixel selection on the mobile device to the GPS coordinates on the map.

1321 is a calculated range based on map scale and anticipated use of the mobile device. In an embodiment of an implementation a fixed range may be a calculated distance from the middle of a typical neighborhood street, residences, and the distance from the street and from each other.

1331 indicates the direction from the mobile device is the intended target.

1332 is the display of the selected direction on the mobile device map.

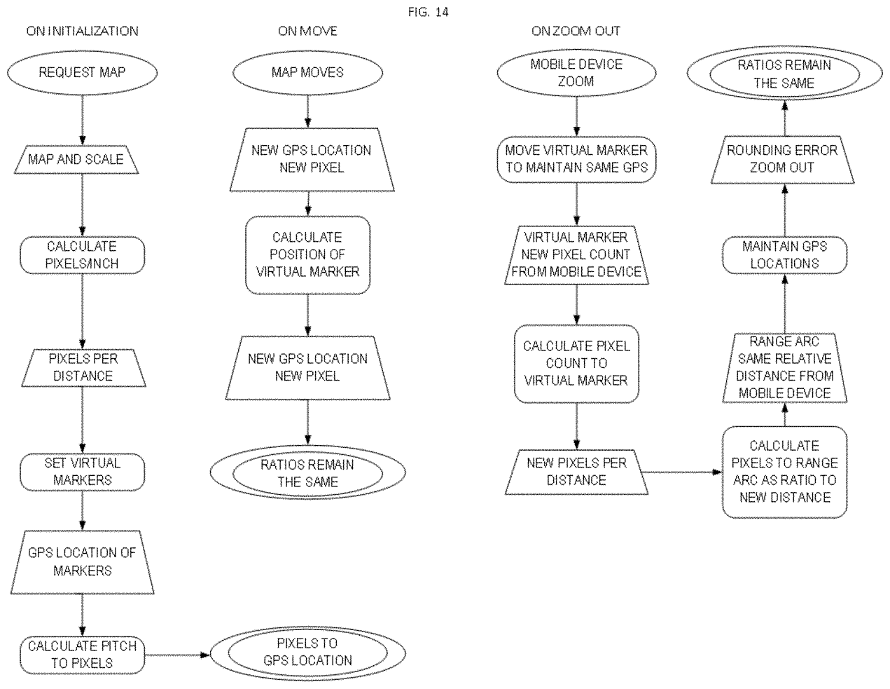

FIG. 14 is a state transition diagram of an implementation. This demonstrates how the GPS mobile device position and GPS target position are maintained as the map changes by repositioning the map to zoom in or zoom out of the map. The preconditions to request a map 1400, is GPS connectivity and data connectivity to request a map. After the map is displayed as pixels on the screen of the mobile device 1407, calculation for map movement 1410 and zooming 1429 will be relative to the initialization.

1400 is a request for a map at a specified scale and centered on a specified GPS location. The requested map is returned for display.

1401 represents the rules for displaying the map on the mobile device screen. The map scale is known because it was part of the initial request. The map is displayed centered on the mobile device location and the map borders are based on the total pixels across and the distance from the mobile device position at the edge.

1402 is the number of pixels per inch to maintain the ratio between mobile device location and any other location. This is required because the initial ratio is pixels per inch to distance per inch 1403.

1403 is derived from the map scale where 1:n equates to 1 inch on the map and n inches on the ground. In 1402 pixels per inch is calculated as pixels is per inch and distance is per inch, pixels per distance is known.

1404 is a marker of fixed distance and the pixel count is known. In an embodiment of an example the fixed distance could be one screen inch, 72 pixels and representing 50,000 inches on the ground.

1405 with knowledge of ground distance of the marker and a default direction from the mobile device GPS location, the calculation of the GPS location of the marker is calculated. For calculations of map movement, the base location of the mobile device GPS location is saved with the GPS location of the marker.

1406 is based on the initial ratio of pitch to distance. The fixed distance to the marker is a ratio of maximum pitch and maximum distance. With the knowledge of 1403 pixels per distance, the angle of pitch to the marker is calculated. This angle of pitch is saved as it is constant. If the map moves or zooms the pitch angle from the mobile device GPS location and the marker remains the same.

1407 is the collection of fixed values, distance of marker from the mobile device and pitch from the mobile device to the marker. Other values are ratios. Pixel distance is a ratio as the map zooms in or out. Pixel location of the mobile device and marker as the map moves.

1410 represents the map moving on the screen and the GPS position of the mobile device and marker remain the same. On map move the GPS location moves to a different pixel.

1411 calculates the updated pixel position of the mobile device. The GPS location of the mobile device remains the same so the position on the map moves with the map.

1412 determines absolute pixel location of the updated marker. An updated pixel location is the corresponding X and Y pixel movement from the original mobile device pixel to the new mobile device pixel.

1413 The marker virtual pixel location is moved the equivalent X and Y axis the same distance and direction as the updated mobile device pixel and the original pixel location.

1414 retains the same ratio of pitch to distance. GPS location remains the same for the mobile device and the marker. Visually the location of the mobile device is different, but the azimuth vector and the range arc remain the same.

1420 represents the map zoom in or map zoom out. The zoom in and zoom out are on the center point of the map. If the mobile device location is in the center, no pixel change. If the mobile device is off center, then the mobile device GPS location and the marker location remains the same and the pixel location may change. The pitch to distance ratio remains the same.

1421 by the zoom, the further from the center of the map the GPS location is, the more it moves in pixels. By the zoom, all reference to scale is lost. Scale is relative to the fixed land distance between the unmoved mobile device GPS location and the stationary marker GPS location.

1422 any pixel distance between the mobile phone location and the marker location must be recalculated.

1423 determines the new pixel count between the mobile device GPS location and the marker location. There are map functions to accomplish this.

1424 is the new scale where the distance between the GPS location and marker location remains the same as the previous distance between them. The number of pixels between them is a ratio of original pixels/original land distance to new pixels/X distance.

1425 retains the same pitch between the mobile device pixel and the marker pitch. The pitch to distance remains fixed, the visual representation on the screen may change. The ratio for calculate pitch to range arc is new pixels/old range arc to X pixels/new range arc.

1426 maintains that the land distance for a given range arc remains constant through zoom in and zoom out, only the presentation of the range distance on the mobile device screen is modified.

1427 displays the mobile device at the same GPS location, but that location may have moved in pixels. Therefore, it will be a new pixel location. The marker independently retains the same GPS location and the pixel location may have moved.

1428 indicates a visual discrepancy on zoom out. At a lower map scale, range arcs move depending on pitch. At a higher map scale where distance between mobile device and marker is constant, the range arc moves less per change in angle. At significant zoom out, the range arc may not move from the pixel position. In an embodiment of an example the where one pixel covers hundreds of miles and one degree of pitch represents 100 feet, change of pitch occurs mathematically but visually the range arc remains stationary.

1429 holds that as the GPS locations remain the same and the range arc ratio remains the same, only the visual representation appears that there is a change.

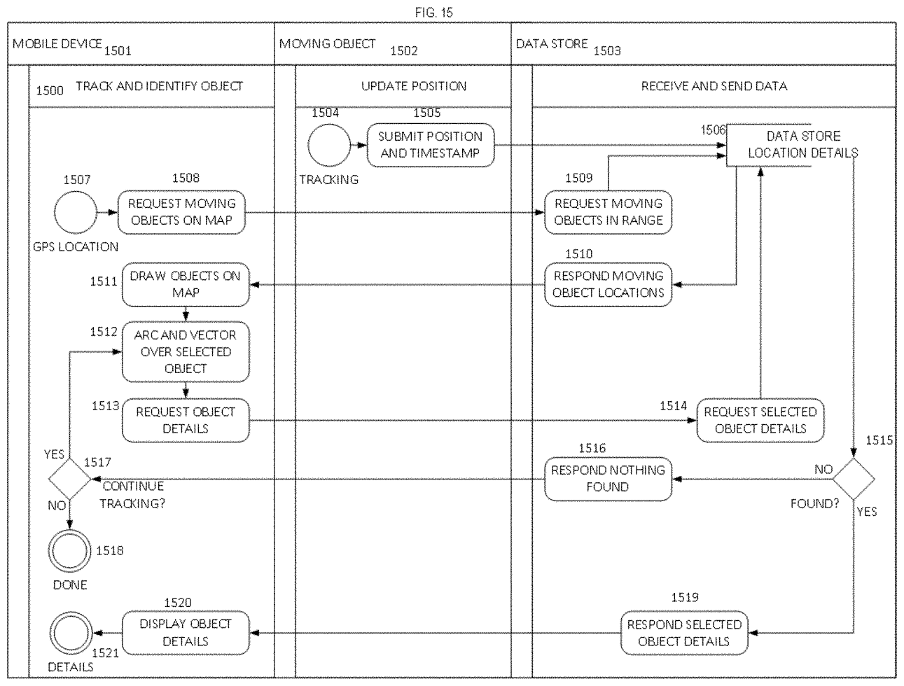

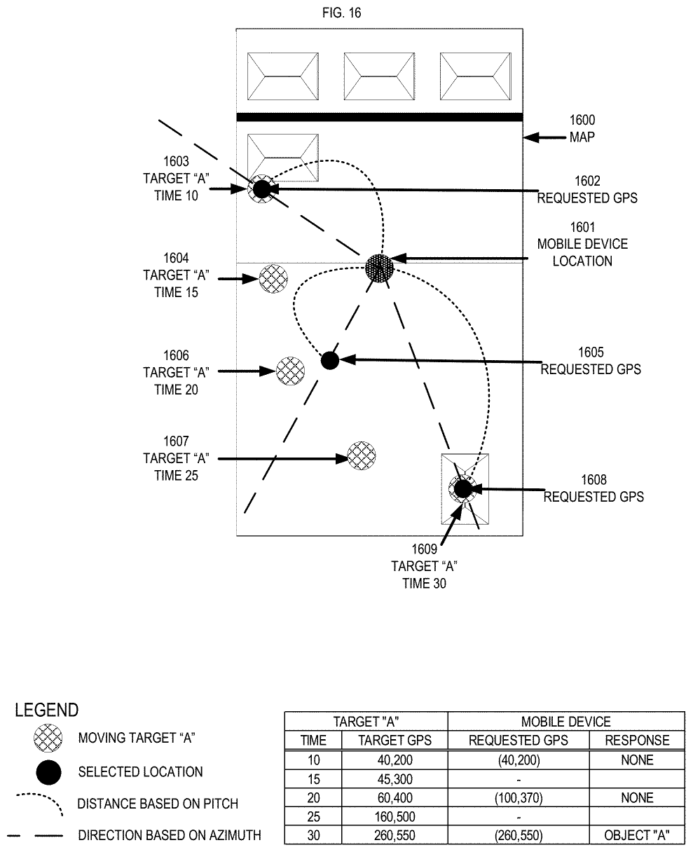

FIG. 15 is an activity diagram delineated by object and activity. Each column shows the activities specific to the object. Each arrow line indicates the flow of activity information. The broadcasting of the GPS location by moving object at 1504 is independent of the mobile device requesting moving objects on the map FIG. 16 1601. 1501 is a column of activities that are implemented in the moving device. 1502 is the column of activities for the moving object that will be tracked. 1503 is the data store where the GPS locations of the moving object and the selected GPS location of the mobile device are stored and compared.

The track and identify object, update position and receive and send data 1500 are the description of the activities pertinent to the tracking and identification of moving objects. The mobile device is capable of other activities such as requesting information on static objects, measuring distances and requesting maps. The moving object while updating position can also have a mobile device and is also tracking other moving objects. The data store includes algorithms for calculating moving object proximity to the mobile device selected location and matching time proximity between the moving object broadcast and the mobile device object identification request.

1501 is the column for activities that the mobile device initiate to identify a moving object. Arrows out indicate data that is transferred to the data store. There is no communication between mobile device and the moving target. If the mobile device is moving that it can also act as a moving object for another mobile device that is tracking. 1502 is the moving object. Its only activity is the broadcasting of the GPS location. GPS broadcasting can be active or passive. An example of an active broadcast is where the moving object is requesting information based on the current GPS location. Passive broadcasting would be where the moving object has a built in GPS broadcaster or an aerial image which can be converted to object GPS locations. 1503 is the data store that receives, stores and sends data from the mobile device and the moving object. The data store has services that will find data meeting requisite criteria.

Moving objects broadcast their location 1504. This is by GPS transponder attached to the object or portable devices that contain GPS transmitters such as mobile devices. From overhead images it is also possible to determine the GPS location of a moving object. In this example the moving object wants to send the GPS location to the data store. The moving object message 1505 includes a unique identification representing the moving object, a time stamp of the date and time that the GPS location was captured and the GPS location to sufficient decimal places.

The data store location details 1506 is a data repository and an interface to respond to queries identification of moving objects. The data store continuously receives GPS location data from moving objects. The data store receives the requested GPS location 1514 from the mobile device. In an example where mobile devices are also moving objects, the GPS location of the mobile device is part of the message and stored in the data store.

The mobile device sets up the map and the situated location of the mobile device 1507. This is the same process as other scenarios indicated in the patent. Where this scenario differentiates itself is that it makes a request for all registered moving objects on the map. The request includes a unique identifier of the mobile device, a date time indication of the request and GPS points that map the outer limit for identification of moving objects. The mobile device request 1508 includes sufficient GPS points to create a convex polygon. A typical rectangular mobile device screen requires two GPS locations, for example an upper left corner visible GPS location and the lower right corner. If the mobile device map scale is modified, then a new request is made with updated GPS polygon points. The data store receives the request 1509 and builds the polygon. The mobile device data request is for all moving object GPS locations that fall with the polygon and are at the same date time. The date time comparison is for a time range, not limited to an exact match. The request GPS polygon from the mobile device is stored in the data store. All the moving devices registered at that date time and within the GPS polygon 1510 are sent as a message to the mobile device.

When the mobile device receives the response 1511, it marks every GPS location provided in the response message. The message may optionally include additional information about the moving objects if it is known. If the map scale on the mobile device has changed between the request and the response, the objects may not display on the mobile device. If zoomed in, then moving objects outside the updated display reside in local memory but cannot be displayed. If zoomed out, moving objects previously outside the polygon, but now within the polygon, will not be immediately displayed. A new request by the mobile device with the updated polygon will result in an updated list.

Pointing the mobile device in the direction of the moving object of interest and using the tilt to indicate distance 1512, the intersection of the azimuth and radius arc indicate the location desired. The moving object is statically displayed on the mobile device screen. When the mobile device intersection is on the moving object of interest a request is made for details of the selected moving object. This can be repeated without limit. Each request for information on the moving object includes the unique identification of the mobile device, date and time of the request and the GPS location of the intersection of the azimuth line and the radius arc 1513. When the data store receives the request 1514, information from the mobile device is saved and a test 1515 is performed to find registered moving objects at the supplied GPS at a matching date and time. If nothing is found at the location specified by the mobile device a response is sent as such. If one or more objects is identified, then details of the selected moving objects is sent to the mobile device 1519. Depending on the required accuracy, it may be multiple requests on the moving object at changing GPS locations to determine the more accurate identity. Multiple identifications of the same moving object by requests from the mobile device, more accurately depict the path of travel of the moving object.

When the mobile device receives a message 1516 that no object has been identified, the mobile device operator may elect to again attempt to select a moving object 1512 or end the attempt 1518. If the mobile device receives a response with a message indicating details of the selected moving object, these details are displayed on the mobile device. The mobile device operator has access 1521 to the information on the selected moving object.

FIG. 16 is an embodiment of an implementation with elapsed time. It is an explanatory diagram illustrating an image and dynamic object movement. It starts with receiving a map FIG. 1 113. The same map 1600 is displayed on the screen of the mobile device. The operator location 1601 is marked on the map for reference. The intersection 1602 of the azimuth vector and the range arc is the location of the object in motion that is being selected. In an exemplary demonstration, the user of the mobile device has been following the movement of the selected object for “10” seconds.

The selected object at 1603 is at the GPS location selected at 1602. The object at 1603 at some recent time passed through the GPS location and transmitted that location to the server FIG. 15 1506. The mobile device selects and sends a request for moving objects at the specified location FIG. 15 1514. The data store compares the recorded GPS location of moving objects at the requested location and at the time of the request. With only one partial identification, the data store returns a message FIG. 15 1516 that nothing can be identified.

The moving object continues traveling and at 1604 submits to the data store an updated position. The mobile device continues to be pointed in the direction of the moving target, keeping the intersection of the azimuth and distance arc over the object to select. At time “20” because the intersection 1605 is not over the moving object 1606, the data store will not identify the object. The moving object continues movement, sending the GPS location to the data server at time 20. The map 1600 is updated with the new position of the moving object 1607.

At time 30 the mobile device azimuth and distance arc are over the moving object 1608 and a request for the object details is made to the data store. The data store identifies where previously the identical moving object was selected 1602 and the details of moving object 1609 is sent to the mobile device FIG. 15 1519. The mobile device displays the details FIG. 15 1520.

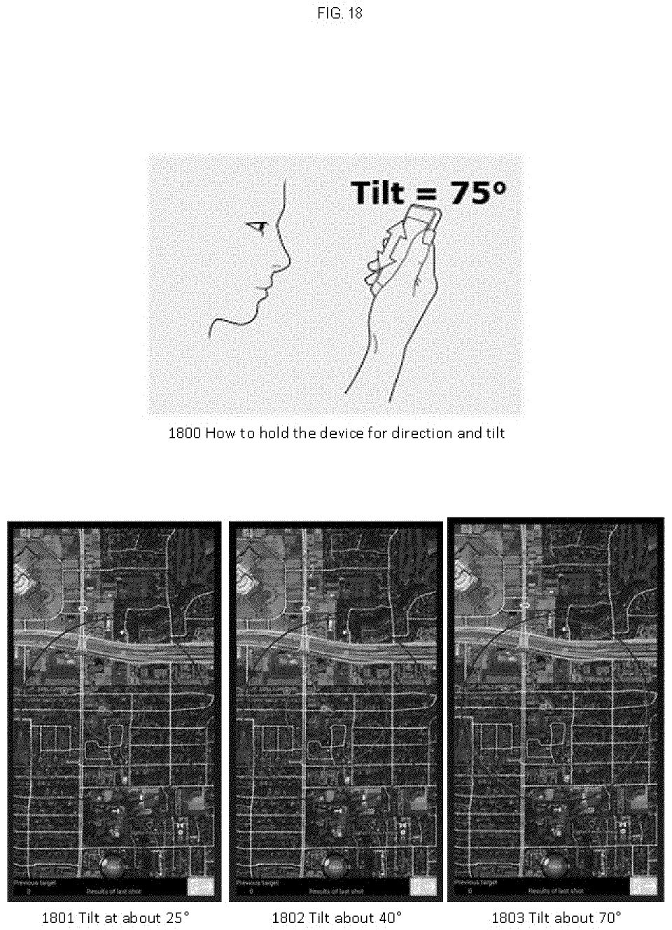

FIG. 18, 1800 Demonstrates how a user might hold a device for the purpose of selecting a target. On the device display is a map of the zone, and the current location of the device (user). Direction (compass reading in degrees) and tilt (in degrees) are displayed on the screen.

1801 Demonstrates the distance (pink circle) that will be selected at that tilt. Tilt is proportional to distance from the center to the zone edge (blue circle). The angle proportion can be configured to any proportion relative to the zone edge. It works with any map scale as small as a city block to half of earth (curvature makes selection at the edges very difficult). 1802 demonstrates how the distance arc might appear with the mobile device at a higher pitch. 1803 is another representation of how the radius arc might appear when the user adjusts the mobile device tilt.

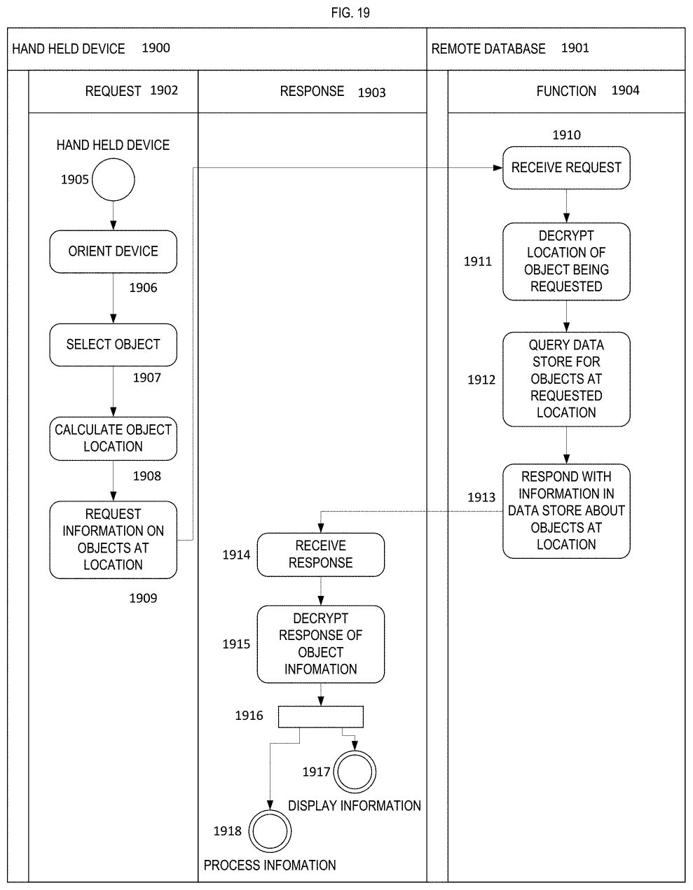

FIG. 19 is an activity diagram delineated by object and activity. Each column shows the activities specific to the object. Each arrow line indicates the flow of activity information. The handheld device 1900 functions with two roles, submitting a request and receiving a response. The remote database 1901 has a single role 1904 of determining the response of the request.

The steps to generate a request are 1902 and the steps to handle a response is 1903. The request is sent to the remote database 1904 for information specific to the response and sending any information found back to the hand held device. The information received by the handheld device may be displayed and/or further processed.

A request 1902 is initiated by the handheld device 1905. By oriented the device in the direction of the target 1906 a straight line, and device tilt to indicate circle radius from the device, the single point of interest 1907 is defined as the intersection of the line and the circle. Calculating the location 1908 of the object is an algorithm to determine the distance based on map scale, and trigonometry to determine the object coordinates. The request for information at the selected coordinates is formulated 1909 for the remote database to algorithm to interpret.

The remote database receives requests 1910 for processing. The request is decrypted 1911 to interpret the coordinates requested for information. The database formulates a query 1912 that incorporates the coordinates for information about objects at the coordinates from the decrypted request. The information is encrypted 1913 following a published structure that the handheld device is anticipating to receive.

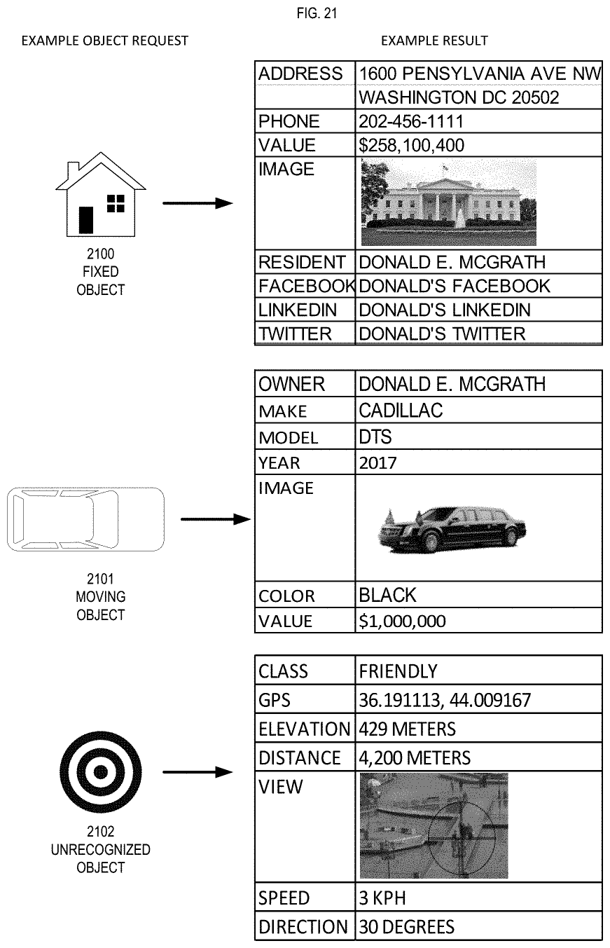

The handheld device receives the response 1914 from the remote database. The response includes encrypted details about objects at the coordinates requested. The handheld device has custom algorithms to decrypt the response into a format that is usable as in FIG. 21. This information can be further processed 1918 by the handheld device and/or displayed on the screen 1917 of the device. Further processing, as an exemplary demonstration, can include subsequent queries to other databases, automated “speech” from text, pulsating light, vibrations and communications with other devices.

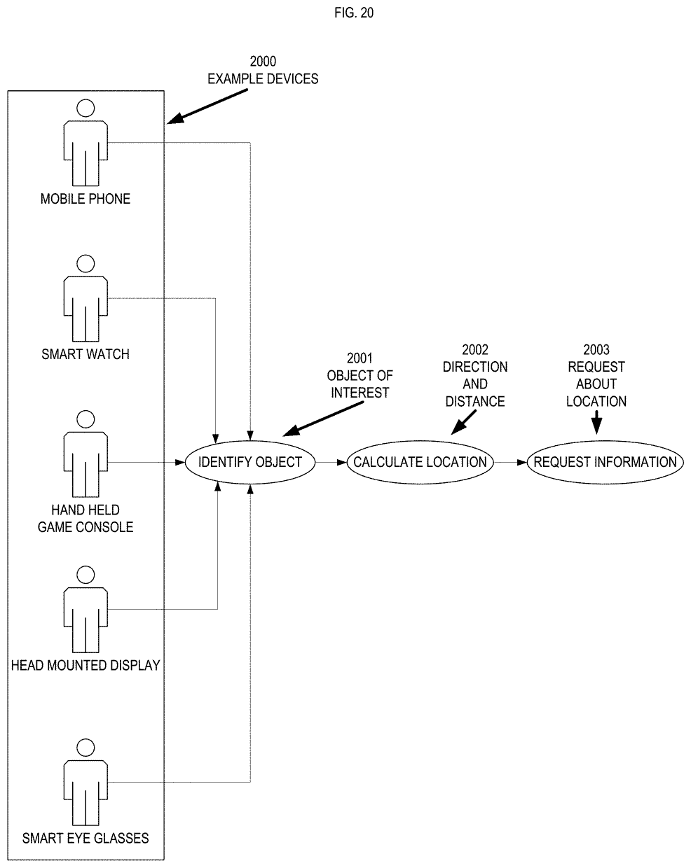

FIG. 20 is an exemplary pictorial representation of how different mobile devices initiate requests for information about specific locations. 2000 identifies some currently available mobile devices that are capable of requesting information. Any of these devices can be oriented in the direction of the target and tilted to indicate distance. They are capable of indicating the selected object of interest and providing the results to the user. Using the paradigm of point and tilt 2001 and immediate feedback to the user indicating the object indicated for selection, similar algorithms for determining a coordinate from distance and direction 2002 are used. As in FIG. 19. 1919, an algorithm running on the hardware converts the coordinates to a request 2003 for information and submits it to the database.

FIG. 21 is an exemplary demonstration of how the results of a query might appear on a mobile device. In the example of a fixed object 2100, because they typically have mailing addresses, tax assessor value and an available image, these can be displayed on the mobile device. Phone number and the name of residents or owners may be available. Where a name is known, much information may be collected and displayed from social media sites.

In an example of a moving vehicle, 2101 vehicles having GPS, vehicle Wi-Fi or cellphones may broadcast the vehicle GPS location at intervals. When vehicle identifiable information is transmitted with the GPS location update, the combination of user selected location of interest and vehicle GPS location at the time selected identifies the what object is selected. With a database of vehicles, vehicle specific information may be displayed on the mobile device screen. See FIG. 16 for example of a user experience to track a vehicle.

In a sophisticated example for the identification of an unknown object, 2102 the object of interest may not be transmitting a GPS location. Using aerial or satellite photography with GPS coordinates, a visualization of the selected object at the requested time may be matched with data in the database. Knowledge of the terrain is generally available and the calculated distance from the mobile device. Additional information, specific to the task may be available and presented on the mobile device screen. As a military application, a soldier points and tilts the mobile device to select for identification an object of interest. With GPS coordinates, a airborne vehicle (drone, satellite or specialized airborne aircraft) aims a camera at the GPS location and obtains an image. The image is processed by special image recognition software to ascertain additional information. The information is transferred to the mobile device for decision support.

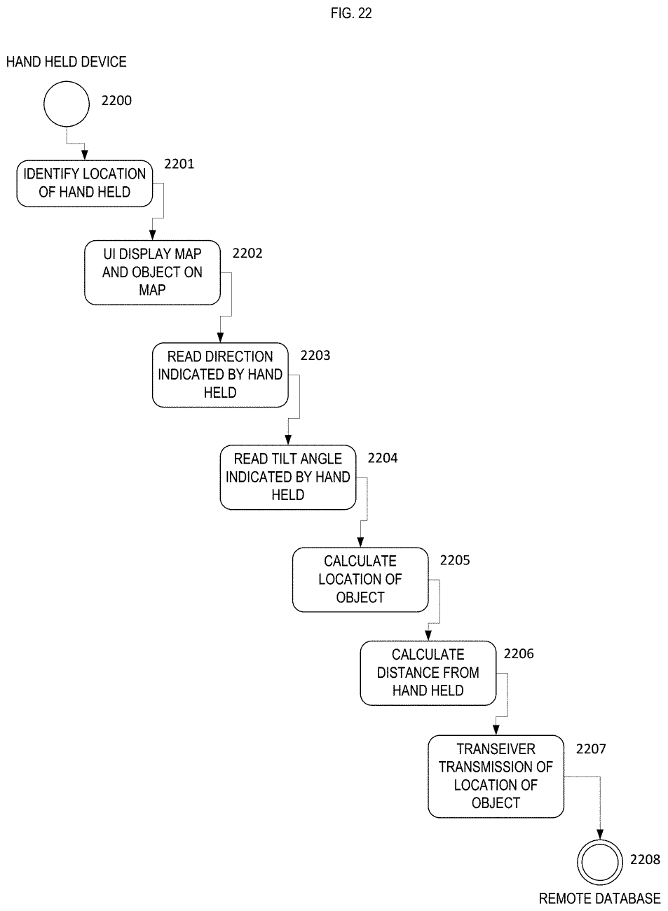

FIG. 22 depicts the data required and a working order for the identification of an object. Beginning with a hand held device 2200, the GPS location 2201 is provided by the hardware to the algorithm. Using the GPS location of the hand held device a map is displayed 2202 that also displays an icon representing the device location on the map. Emanating from the device location icon on the map is a straight line following the direction 2203 the device is pointing. As the user changes direction that the device is pointing, the direction of the straight line on the map correspondingly changes. The tilt of the mobile device 2204 is reflected in a circle with the device at the center. The circle pulsates bigger or smaller based on the tilt of the device. The location where the line and circle intersect is the GPS location to be calculated. Utilizing pixel resolution and map scale, the GPS location of the object 2205 is determined. The distance 2206 from the handheld can be calculated as the distance between two GPS locations. The algorithm in the mobile device transmits pertinent data 2207 to the data store where the database 2208 receives the request for fulfillment.

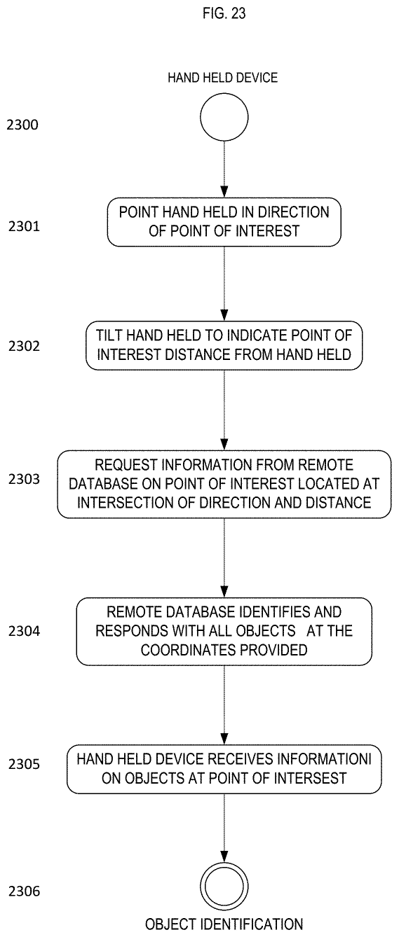

FIG. 23 is an exemplary demonstration of the experience of the mobile device user. Beginning 2300, the user has a mobile device. The user points the hand held device 2301 at or in the direction of the target of interest. To specify the exact location on the straight line, the user tilts the device 2302 so that the circle and the direction line intersect over the object of interest. By command of the user 2303, a request of information at the intersection is sent to the remote database. There may be a delay in response due to latent connectivity and the remote database 2304 internal operations. The response is received by the hand held device 2305 and the information provided in the response is displayed on the screen. The user has information on the object identified 2306.

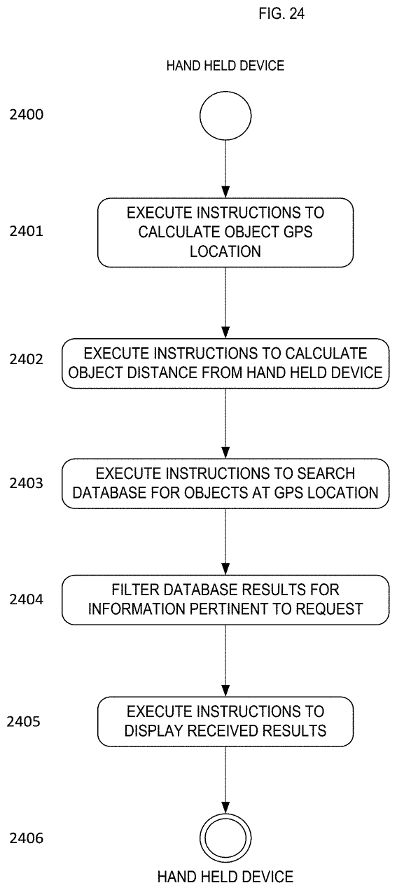

FIG. 24 is an exemplary demonstration of steps in the algorithm. The process begins with a mobile device 2400. The algorithm first identifies the location 2401 of the mobile device. After receiving the GPS location of the target object 2402 the algorithm calculates the distance of the GPS selected object location from the mobile device. An algorithm on the remote database queries the database for records that meet the criteria of the GPS location 2403 and other pertinent information that may be required, such as recorded time stamp of the object at the specific location. Prior to responding with the database information, the algorithm validates 2405 that the information that will be sent to the mobile device meets business configurable rules to implement legally required safeguards. The information is captured by the hand held device 2406 for the algorithm to process further.

1. A computer-implemented system for identifying object using the hand held device, the system comprising:
(a) a hand held device obtaining object identification information and transmitting the object identification information; and
(b) a remote database unit receiving the object identification information request, retrieving object identification information, identifying object based on the object identification information, and returning object identification information to the hand held device for display.

2. The system of claim 1, wherein the hand held device can be any mobile device with processor.

3. The system of claim 1, wherein the object identification information comprises personal data information of the object.

4. The system of claim 1, wherein the hand held device further comprises:
(a) a GPS sensor identifying the hand held device map location;
(b) a user interface creating an object map location using identified object and displaying the object map location;
(c) a direction sensor selecting the object on the object map location;
(d) a tilt sensor selecting the object on the object map location;
(e) a map processor identifying object position relative to the two dimensional coordinates system and a hand held heading;
(f) a processor calculating a distance from the hand held to the object;
(g) a wireless transceiver transmitting the object identification information request to the remote database unit and output from the remote database unit.

5. The system of claim 4, wherein the processor comprises computer executable instructions for calculating the distance from hand held to the object.

6. The system of claim 4, wherein the map processor has functional characteristic information and spatial characteristic information of the object.

7. The system of claim 4, wherein the user interface displays the object in different color in an image icon on the object map location.

8. The system of claim 4 wherein the transceiver transmits object location and time at the location.

9. The system of claim 4 wherein the transceiver receives response from the remote database on additional details about the object as the location.

10. A computer-implemented method for identifying an object to be executed by a processor in a hand held device, comprising the steps of:
(a) orienting the hand held device toward a point of interest wherein the point of interest is directing a straight line from the hand held;
(b) tilting an angle of the hand held device from any angle to the earth to select a distance such that the object can be selected on the map;
(c) forwarding a search request to retrieve object identification information including an object position relative to the two dimensional coordinates system and a hand held heading;
(d) querying an associated topographic map database to identify one or more objects coordinates located on the topographic map along the hand held device heading; and
(e) returning object identification information on the portable device.

11. The method of claim 10, wherein the step of tilting an angle of the hand held device further comprises a step of calculating a distance from the hand held to the object.

12. The system of claim 10, wherein the remote database unit comprises computer executable instructions for retrieving object identification information.

13. The system of claim 10, wherein the remote database unit stores object identification information.

14. A processor in the hand held having computer executable instructions recorded thereon for identifying the object identification information, comprising:
(a) interface computer executable instructions for collecting object map location;
(b) computer executable instructions for calculating the distance from the hand held device to the object map location;
(c) computer executable instructions for searching object identification information based on collected object map location;
(d) computer executable instructions for retrieving object identification information;
(e) computer executable instructions for displaying object identification information.
